(19) United States
(12) Patent Application Publication
(10) Pub. No.: US 2026/0301257 A1
(43) Pub. Date: Oct. 1, 2026

(54) GENERATIVE IMAGE CLONING

(71) Applicant: ADOBE INC., SAN JOSE, CA (US)

(72) Inventors: Ajay Bedi, Noida (IN); Nishant Gupta, Noida (IN)

(21) Appl. No.: 19/092,049

(22) Filed: Mar. 27, 2025

(51) Int. Cl. G06T 11/60; G06F 40/40; G06T 3/60; G06T 7/11; G06T 7/50

(52) U.S. Cl. CPC G06T 11/60; G06F 40/40; G06T 3/60; G06T 7/11; G06T 7/50; G06T 2200/24; G06T 2207/20021

(57) ABSTRACT

A method, apparatus, non-transitory computer readable medium, and system for image generation include obtaining an input image including a source object and a target region. A target mask is computed based on the source object and the target region. The target mask has a shape of the source object and is located within the target region. An image generation model generates an output image based on the input image and the target mask, wherein the output image includes a synthetic variant of the source object in the target region.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, involves the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image processing. In some embodiments, an image processing apparatus receives an input image. A user selects a source region from the input image, where the source region includes an original object to be copied. The user selects a destination region, e.g., a location for placing one or more additional objects. The image processing apparatus, using an image generation model, generates a synthetic image that includes the one or more additional objects in the destination region. The destination region may be referred to as a target region. The one or more additional objects are referred to as synthetic variants of the source object.

A method, apparatus, non-transitory computer readable medium, and system for image processing are described. One or more embodiments of the method, apparatus, non-transitory computer readable medium, and system include obtaining an input image including a source object and a target region; computing a target mask based on the source object and the target region, where the target mask has a shape of the source object and is located within the target region; and generating, using an image generation model, an output image based on the input image and the target mask, where the output image includes a synthetic variant of the source object in the target region.

A method, apparatus, non-transitory computer readable medium, and system for image processing are described. One or more embodiments of the method, apparatus, non-transitory computer readable medium, and system include obtaining an input image including a source object and a target region; dividing the target region into a set of cloning regions; and generating, using an image generation model, an output image based on the input image and the set of cloning regions, where the output image includes a set of synthetic variants of the source object corresponding to the set of cloning regions.

An apparatus, system, and method for image processing are described. One or more embodiments of the apparatus, system, and method include a memory component; a processing device coupled to the memory component, the processing device configured to perform operations comprising: obtaining an input image including a source object and a target region; computing a target mask based on the source object and the target region, where the target mask has a shape of the source object and is located within the target region; and generating, using an image generation model, an output image based on the input image and the target mask, where the output image includes a synthetic variant of the source object in the target region.

### BRIEF DESCRIPTION OF THE DRAWINGS

FIG. 1 shows an example of an image processing system according to aspects of the present disclosure.

FIG. 2 shows an example of a method for conditional media generation according to aspects of the present disclosure.

FIG. 3 shows an example of a user interface for image processing according to aspects of the present disclosure.

FIG. 4 shows an example of a user interface for image processing and region selection according to aspects of the present disclosure.

FIG. 5 shows an example of a user interface displaying objects with low creativity according to aspects of the present disclosure.

FIG. 6 shows an example of a user interface displaying objects with high creativity according to aspects of the present disclosure.

FIG. 7 shows an example of a method for image processing according to aspects of the present disclosure.

FIG. 8 shows an example of an image processing apparatus according to aspects of the present disclosure.

FIG. 9 shows an example of a guided diffusion model according to aspects of the present disclosure.

FIG. 10 shows an example of a U-Net architecture according to aspects of the present disclosure.

FIG. 11 shows an example of a diffusion process according to aspects of the present disclosure.

FIG. 12 shows an example of a diffusion transformer according to aspects of the present disclosure.

FIG. 13 shows an example of a user interface including an opacity parameter according to aspects of the present disclosure.

FIG. 14 shows an example of a user interface displaying a selected region according to aspects of the present disclosure.

FIG. 15 shows an example of a user interface displaying an output image according to aspects of the present disclosure.

FIG. 16 shows an example of a source region and a target region according to aspects of the present disclosure.

FIG. 17 shows an example of generating a mask based on a source object according to aspects of the present disclosure.

FIG. 18 shows an example of generating a set of cloning regions according to aspects of the present disclosure.

FIG. 19 shows an example of a transformation process based on a spacing parameter according to aspects of the present disclosure.

FIG. 20 shows an example of a set of cloning regions based on a spacing parameter according to aspects of the present disclosure.

FIG. 21 shows an example of a user interface displaying a set of target regions according to aspects of the present disclosure.

FIG. 22 shows an example of a user interface displaying an output image according to aspects of the present disclosure.

FIG. 23 shows an example of a method for image processing according to aspects of the present disclosure.

FIG. 24 shows an example of a method for computing a set of target masks according to aspects of the present disclosure.

FIG. 25 shows an example of a method for training a diffusion model according to aspects of the present disclosure.

FIG. 26 shows an example of a step-by-step procedure for training a machine learning model according to aspects of the present disclosure.

FIG. 27 shows an example of a computing device for image processing according to aspects of the present disclosure.

### DETAILED DESCRIPTION

The present disclosure describes systems and methods for image processing. In some embodiments, an image processing apparatus receives an input image. A user selects a source region from the input image, where the source region includes an original object to be copied. The user selects a destination region, e.g., a location for placing one or more additional objects. The image processing apparatus, using an image generation model, generates a synthetic image that includes the one or more additional objects in the destination region. The destination region may be referred to as a target region. The one or more additional objects may be referred to as synthetic variants of the source object.

Image editing software can be used for various tasks, such as image editing, image restoration, image generation, etc. Conventional image editing tools or clone tools facilitate copying pixels from a first region to a second region in a same image. As a pixel-level copying tool, they lack the capability to extract a desired object in a precise shape. Moreover, the pixel-level operation is labor-intensive and lacks control for users. In some cases, straight copying lacks generative creativity and may not integrate seamlessly with new backgrounds.

The present disclosure describes systems and methods that improve on conventional image processing models by generating additional objects (the “clones”) based on a target mask, incorporating parameters including creativity parameter, spacing parameter, opacity parameter, style parameter, or any combination thereof.

Embodiments of the present disclosure include an image processing apparatus that takes an input image including a source object and a target region as input. A source region of the input image includes the source object. A target region of the input image is a desired location for placing one or more synthetic variants of the source object generated by an image generation model. The system generates a synthetic image using an image generation model, where the synthetic image includes the copied object in the second region. The image processing apparatus incorporates generative fill features using a diffusion model.

In some embodiments, the image processing apparatus includes an image segmentation model that generates a mask corresponding to a shape of the source object. The source object within the mask is used as a reference image for image synthesis.

Users have increased control over the object cloning process by specifying a set of parameters, including a level of creativity, a level of spacing, a style parameter, and/or a text prompt. The image processing apparatus takes the user-specified parameters as input (or default parameters if no user input is received). For example, the level of creativity parameter indicates a degree of similarity between the source object and the synthetic variant. The spacing parameter indicates a level of sparsity of synthetic variants within the target region (e.g., crowded vs. sparse). The text prompt, as a form of text guidance, guides the image generation model for image synthesis. By enabling these parameters, users have improved control over the creative process compared to conventional clone tools.

In some examples, the user selects a level of creativity on a user interface of the image processing apparatus (e.g., none, low, medium, or high). A lower level of creativity refers to a high degree of visual similarity between the original object and the synthetic variants. A higher level of creativity corresponds to a low degree of visual similarity between the original object and the synthetic variants (i.e., generated objects are visually distinct from the original object). In some examples, the user selects a spacing parameter (e.g., sparse, medium, tight or auto) on the user interface. The spacing parameter is used to control a level of sparsity among the synthetic variants in the destination region. If the spacing parameter is set to “automatic”, the image processing apparatus can intelligently identify the proper transformation and size of the generated objects. If a spacing parameter is set to “sparse”, the image processing apparatus generates relatively fewer synthetic variants in the destination region (e.g., two generated objects placed next to each other). The size of the generated objects may be relatively large. If a spacing parameter is set to “tight”, the image processing apparatus generates more synthetic variants in the destination region to fill the destination region (e.g., eight generated objects are placed in the same destination region to look tight). The size of the generated objects may be relatively small.

In some examples, the user selects a style parameter on the user interface to match original object or certain pattern preset. If the “match original” option is selected, the generated object shows a visual effect that is consistent with the style of the original object. If the “pattern” option is chosen, the generated object shows a pre-determined or user-specified pattern or style. In some examples, the user selects an opacity parameter on the user interface, which adjusts the transparency or translucency of the generated object.

In some embodiments, the image processing apparatus determines the repetition of the generated object within the target region based on the spacing parameter. In some examples, if the spacing parameter is set to “single”, one single synthetic variant is generated and placed within the target region. If the spacing parameter is set to “sparse”, relatively few objects (e.g., two) are generated and place within the target region. If the spacing parameter is set to “tight”, relatively more synthetic variants are generated and placed within the target region. In some cases, the spacing parameter is set to “auto” and the image processing apparatus intelligently determines the proper transformation and size of the synthetic objects. To determine the repetition of objects, the image processing apparatus divides the target region into a set of cloning regions, and the target mask is located within each of the cloning regions. The output image includes a set of synthetic variants corresponding to the set of cloning regions, respectively. In some examples, the synthetic variants may be rotated according to an angle based on the target region and the spacing parameter. The image processing apparatus generates a set of synthetic variants of the source object at the target region in a flexible and desired quantity following a single click.

In some embodiments, the image processing apparatus extracts a source region from same or other document as reference data. The source region may be extracted either from the same document or a different document. In some examples, the user marks the region on the document using a brush tool within the generative clone application and presses the “enter” key to accept the source region. The user may add or modify the source region selection.

A language generation model is used to understand the objects within the reference data and generates possible creative variations. Once the source region is selected, the language generation model performs region-analysis. This includes understanding the objects which are part of the selected region by the user. The language generation model is used to obtain this information. In some examples, vLLM (e.g., Llava and intern VL based visual LLM) is used to understand the object quickly and generates creative variations of that object as well based on a level of creativity specified by users.

In some embodiments, the image processing apparatus performs intelligent mask transformation and clone brush parameters assignment. When the user selects the destination region using brush, multiple computations are performed as mentioned below based on the various tool options/parameters and region selected. In some examples, the image processing apparatus sets brush parameters of the Generative Clone tool based on the source region as well as transforming the object mask based on the destination region. The image processing apparatus calculates the bounding boxes for clones. The image processing apparatus finds the bounding box of the source object and finds the bounding box of the destination region. For single object placement, the image processing apparatus uses the destination bounding box as it is. For sparse and tight spacing placement, the image processing apparatus divides the destination region into multiple rectangles. In some examples, the image processing apparatus rotates the bounding boxes of the destination region and source object to align with the X-Y axis and translates them to the origin. The image processing apparatus calculates the transformation matrix to rotate and translates the rectangular back to the destination region. The image processing apparatus calculates the rectangles for clones by placing the source rectangle in the destination rectangle in a grid-wise manner. For the sparse placement option, the image processing apparatus removes alternate rectangles such that no two rectangles share an edge. The image processing apparatus applies the transformation matrix calculated in the above step to each rectangle and aligns them in the destination region. The image processing apparatus generates a vector of rectangles where cloning is to be done. In the case of the single object option, the vector would contain a single rectangle.

Next, the image processing apparatus calculates the masks for generative fill. If low-level creativity or high-level creativity is selected, the image processing apparatus directly converts these rectangles into masks. If a user selects no creativity, the image processing apparatus would clone the source object without any modifications. The image processing apparatus calculates the transformation matrices from the original source rectangle to the transformed destination rectangles. The image processing apparatus transforms the source object mask using these transformation matrices. The image processing apparatus applies opacity to the transformed masks.

The image processing apparatus performs conversion of destination masks with auto-computed opacity. The image processing apparatus performs object cloning in the destination region based on masks and parameters. Once the proper masks along with their transformation matrix and corresponding prompts are created, the image processing apparatus, using an image generation model, generates the outputs. In some cases, the image processing apparatus may repeat steps above based on the spacing parameter. If there is more than one mask computed, the image processing apparatus repeats the step for each mask and transformation matrix and parameters as described above.

The present disclosure describes systems and methods that improve on conventional image processing models by increasing the efficiency of cloning a source object in a target region in an output image. The image processing system, using a diffusion model or a diffusion transformer, generates one or more synthetic variants of a source object based on user-specified parameters. For example, the image processing system provides users with flexibility to control different aspects of the desired objects (to be generated), such as adjusting a creativity parameter, a spacing parameter, a style parameter, an opacity parameter. Users have control over a degree of similarity between a synthetic variant and the source object in the output image. Therefore, the efficiency of image editing and object cloning are improved.

The term “source object” refers to an object in an input image, where the object of interest is to be “cloned” to a destination region. The term “target region” refers to the destination region containing the “cloned” object or objects with certain variation, modification or style change applied.

The term “target mask” refers to a mask which has a shape of the source object and is located within the target region mentioned. During an image generation process, the target mask is used to include or exclude certain elements during processing. Masks may be represented as binary matrices (or tensors) containing values such as 1 and 0. For example, 1 (or True) represents keeping or including a value (element). 0 (or False) represents ignoring, hiding or excluding a value (element).

The term “synthetic variant” refers to a new generated object in the target region. A synthetic variant may be viewed as a “clone” of the source object while the synthetic variant may look differently from the source object (e.g., variation, style change) depending on user-specified parameter(s). The “output image” includes one or more synthetic variants in the target region while preserving the background from the input image.

### Image Processing

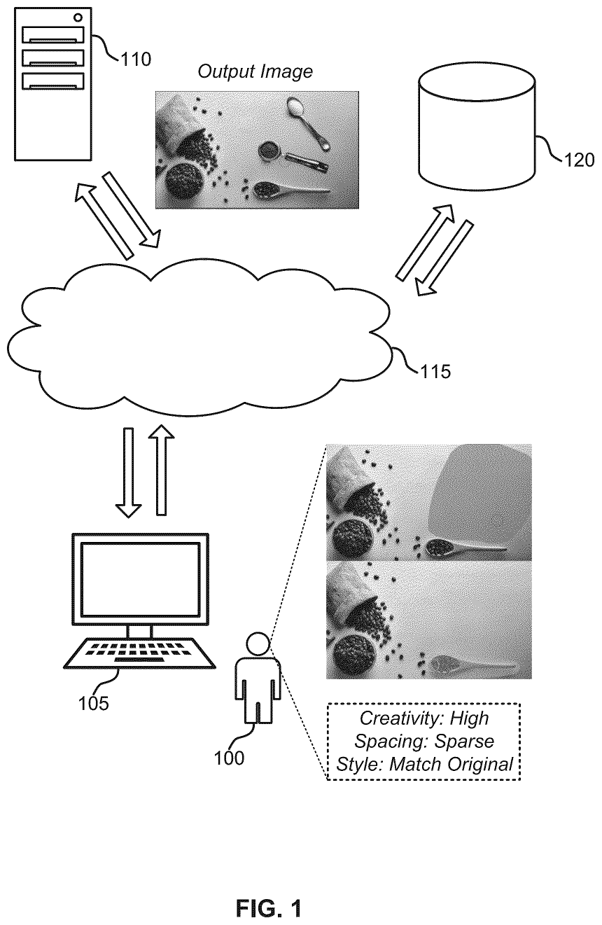

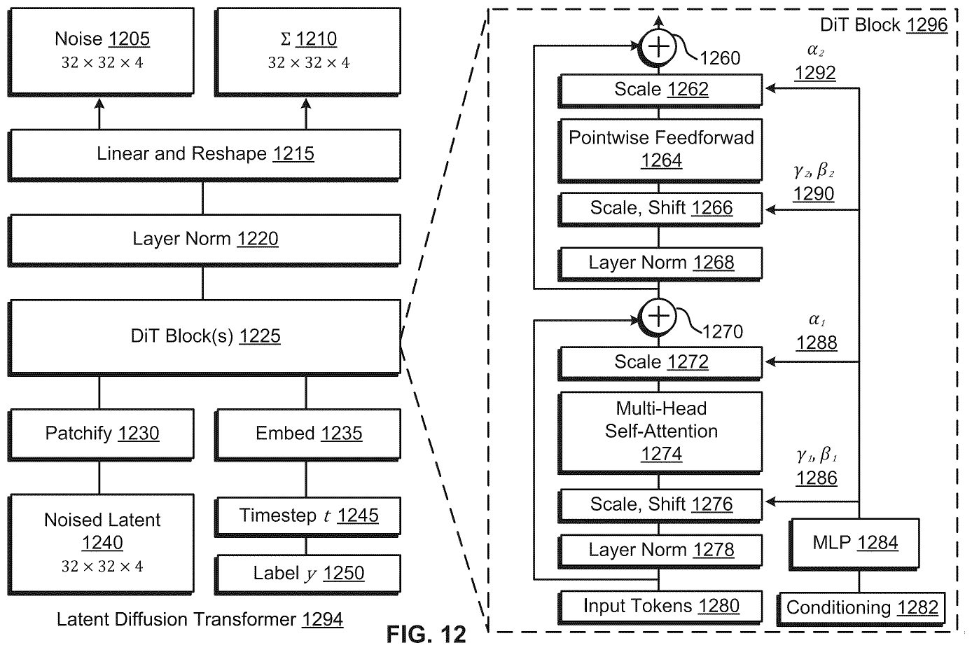

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 12.

In FIG. 1, an input image including a source object and a target region specified by user 100. User 100 wants to create one or more synthetic variants of the source object in the target region. User 100 selects parameters such as creativity parameter, spacing parameter, style parameter, etc. The creativity parameter indicates a degree of how closely the synthetic variant resembles the source object. If user 100 selects “high” creativity, the synthetic variant looks relatively different from the source object (i.e., more creative). For example, image processing apparatus 110 generates a steel sugar spoon (different from a wooden coffee spoon). If user 100 selects “low” creativity, the synthetic variant looks similar to the source object (i.e., resemble the source object in overall appearance). For example, image processing apparatus 110 generates another wooden coffee spoon that looks highly similar to the source object. If user selects “medium” creativity, a degree of similarity between the synthetic variant and the source object is between high-level creativity and low-level creativity. If user 100 selects “None” creativity, the synthetic variant is a same object as the source object (i.e., no variation).

In some examples, the spacing parameter (“tight” spacing, “sparse” spacing, “medium” spacing, etc.) indicates a level of sparsity (or tightness) about the spacing and arrangement of the synthetic variants in the target region. In some examples, the style parameter refers to “match original” parameter or “pattern” parameter. The style parameter is used to control whether the synthetic variant matches a style of the source object or follow a different pattern/style. In some cases, a target region may have a regular shape such as a circle or a rectangular specified by a bounding box. Alternatively, the target region may have an irregular shape specified by user 100 using a brush tool (as the example shown in FIG. 1).

The input image or the output image is a raster image or a vector image. The input image, selected source object, selected target region, selected parameters are transmitted to image processing apparatus 110, e.g., via user device 105 and cloud 115. In the above example, the input image depicts a bag and a bowl of coffee beans with a wooden spoon holding coffee beans. The source object is the wooden spoon and the target region is a shaded region above the source object (an irregular region selected using a brush tool). Selected parameters include “Creativity: High”, “Spacing: Sparse”, and Style: Match Original”, etc.

Image processing apparatus 110 generates an output image based on the input image, the source object, and the target region. The output image includes a synthetic variant of the source object inside the target region. The output image is identical to the input image in areas outside the target region. The output image includes a first synthetic variant and a second synthetic variant sparsely spaced in the target region. The first synthetic variant is a steel coffee spoon and the second synthetic invariant is a steel sugar spoon (because the creativity parameter is set to “High”), different from the wooden spoon.

The first synthetic variant and the second synthetic variant contain some objects inside (e.g., ground coffee in the first synthetic variant, sugar in the second synthetic variant), similar to the coffee beans (because the style parameter is set to “Match Original”).

Image processing apparatus 110 computes a target mask based on the source object and the target region, where the target mask resembles the shape of the source object and is located within the target region. The output image is generated based on the input image and the target mask. Image processing apparatus 110 returns the output image to user 100 via cloud 115 and user device 105. In some cases, the output image is transmitted, via cloud 115, to database 120 for storage and further editing.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

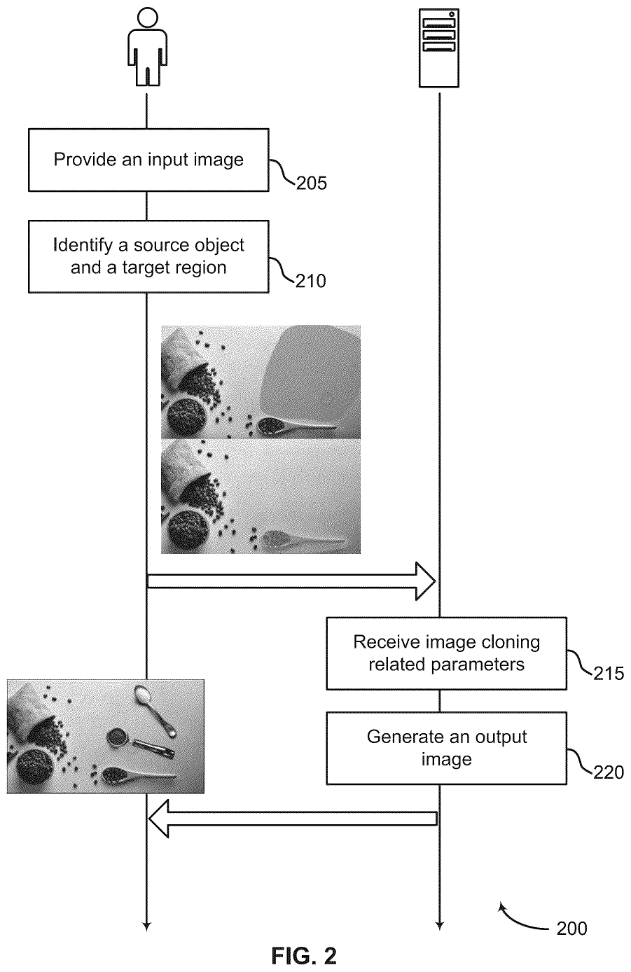

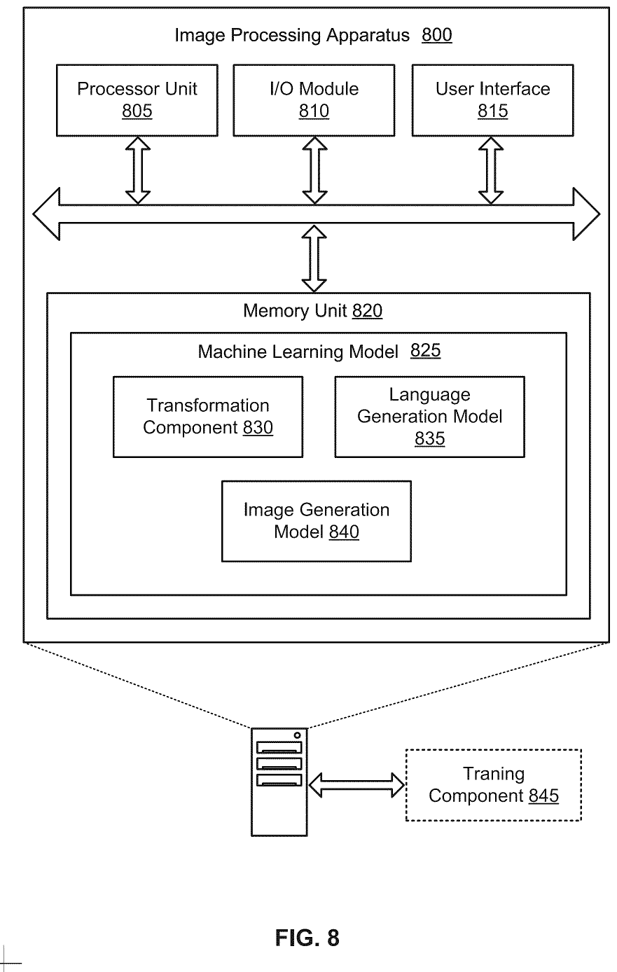

Image processing apparatus 110 includes a computer-implemented network comprising a transformation component, a language generation model, and an image generation model. Image processing apparatus 110 may also include a processor unit, a memory unit, an I/O module, and a user interface. A training component may be implemented on an apparatus other than image processing apparatus 110. The training component is used to train machine learning model 825 described with reference to FIG. 8. The training component is an example of, or includes aspects of, training component 845 as described with reference to FIG. 8. Additionally, image processing apparatus 110 can communicate with database 120 via cloud 115. In some cases, the architecture of the image generation network is also referred to as a network, a machine learning model, or a network model. Further detail regarding the architecture of image processing apparatus 110 is provided with reference to FIGS. 8-12. Further detail regarding the operation of image processing apparatus 110 is provided with reference to FIGS. 2, 7, and 13-24.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training an image generation model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

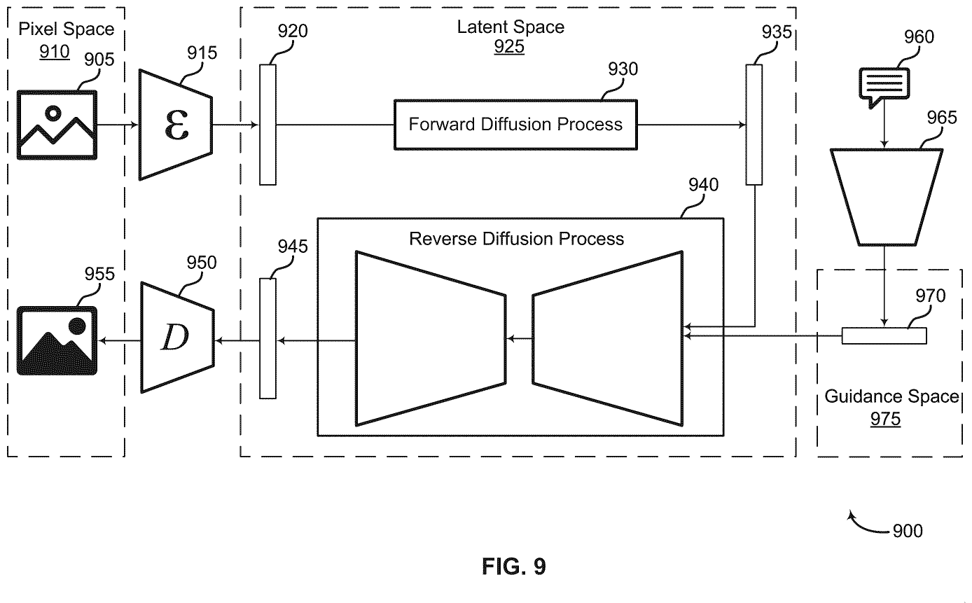

FIG. 2 shows an example of a method 200 for conditional media generation according to aspects of the present disclosure. In some examples, method 200 describes an operation of the image generation model 840 described with reference to FIG. 8 such as an application of the guided latent diffusion model 900 described with reference to FIG. 9 or a diffusion transformer described with reference to FIG. 12. The method 200 is performed by user 100 interacting with image processing apparatus 110 via user device 105 as described with reference to FIG. 1. In some examples, these operations are performed by a system including a processor executing a set of codes to control functional elements of an apparatus such as the image processing apparatus described in FIGS. 1 and 8.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides an input image. In some cases, the operations of this step refer to, or may be performed by, a user as described with reference to FIG. 1. In some cases, the input image is a raster image or a vector image. In an example illustrated in FIG. 2, the input image depicts a bag and a bowl of coffee beans, with a wooden spoon holding some coffee beans.

At operation 210, the user identifies a source object and a target region based on the input image. In some cases, the operations of this step refer to, or may be performed by, a user as described with reference to FIG. 1. In some cases, the source object and the target region are selected using a bounding box, a preset shape (a regular shape), a brush tool (an irregular shape), etc. In the above example, the selected source object is the wooden spoon holding coffee beans. The selected target region refers to the shaded and irregular region located above the source object.

At operation 215, the system receives image cloning related parameters including a creativity parameter, a spacing parameter, a style parameter, and so on. In some cases, the operations of this step refer to, or may be performed by, an image processing apparatus as described with reference to FIGS. 1 and 8. In some cases, the creativity parameter indicates a degree of resemblance between a generated object and the selected source object. The spacing parameter indicates a level of sparsity among generated objects in the target region of an output image. In some examples, the creativity parameters may be set to “None”, “Low”, “Medium”, or “High”. The spacing parameters may be set to “Tight”, “Medium”, or “Sparse”.

At operation 220, the system generates an output image including a synthetic variant of the source object. In some cases, the operations of this step refer to, or may be performed by, an image processing apparatus as described with reference to FIGS. 1 and 8. The synthetic variant of the source object is located inside the target region. In some cases, the image processing apparatus generates a set of synthetic variants of the source object. The set of synthetic variants may look similar, identical, or different from each other.

The output image may look identical to the input image in areas outside the target region (i.e., background is kept the same). The first synthetic variant and the second synthetic variant look different from the source object because the creativity parameter is set to “High”. The first synthetic variant and the second synthetic variant are sparsely spaced in the target region because the spacing parameter is set to “Sparse”.

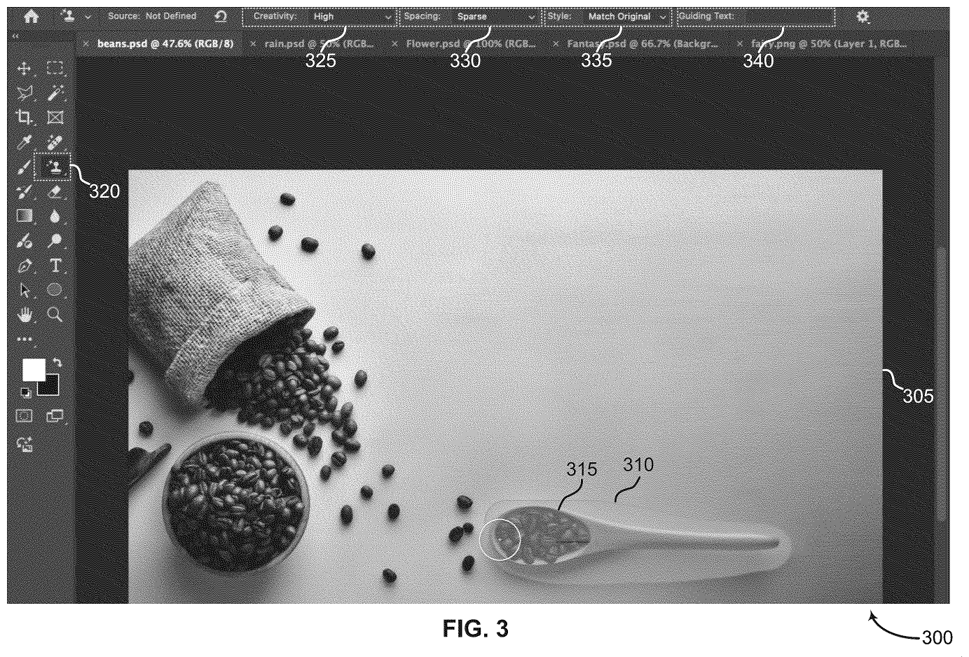

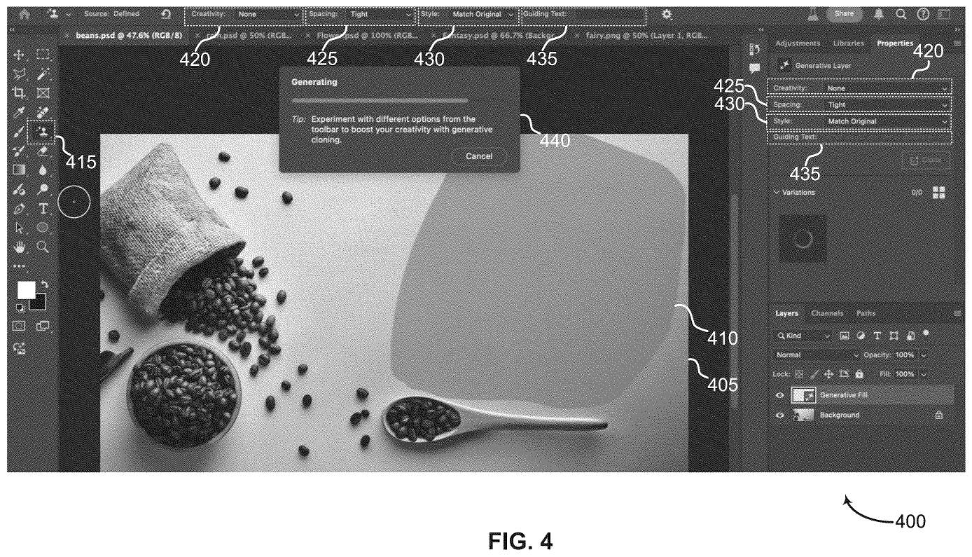

FIG. 3 shows an example of a user interface 300 for image processing according to aspects of the present disclosure. The example shown includes user interface 300, input image 305, source region 310, source object 315, cloning tool 320, creativity parameter 325, spacing parameter 330, style parameter 335, and text prompt 340. User interface 300 is an example of, or includes aspects of, the corresponding element described with reference to FIGS. 4-6, 8, 13-15, 21, and 22. In FIG. 3, the left toolbar includes cloning tool 320 which a user selects by clicking on it. Then the user selects source region 310. The user may select various options from the tool's option bar, e.g., level of creativity, spacing, style, auto, etc. The user marks a destination region as described below in FIG. 4.

According to an embodiment, user interface 300 obtains input image 305 including a source object 315. The source object 315 is located within source region 310 selected by user 100 using a brush tool (an irregular shape). In some examples, user interface 300 obtains a creativity parameter 325 that indicates a degree of similarity between source object 315 and a synthetic variant (to be generated). User interface 300 obtains a spacing parameter 330 (e.g., “Sparse”), where the target region is divided based on the spacing parameter 330. In some examples, user interface 300 obtains an opacity parameter indicating a level of opacity for the synthetic variant. In some examples, user interface 300 obtains a style parameter 335 indicating a style attribute for the synthetic variant (e.g., “Match Original”).

In some examples, user interface 300 obtains the creativity parameter 325, the spacing parameter 330, the style parameter 335, the opacity parameter, or any combination thereof.

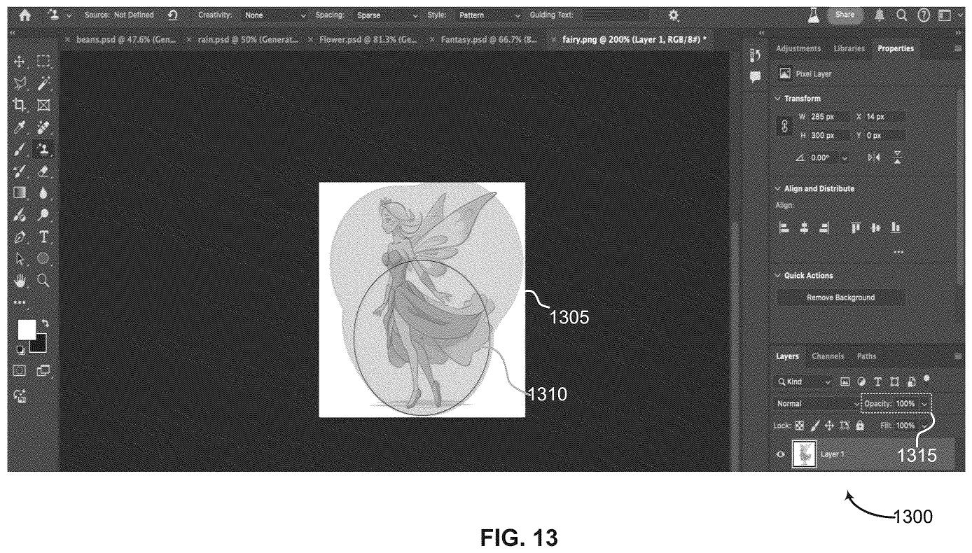

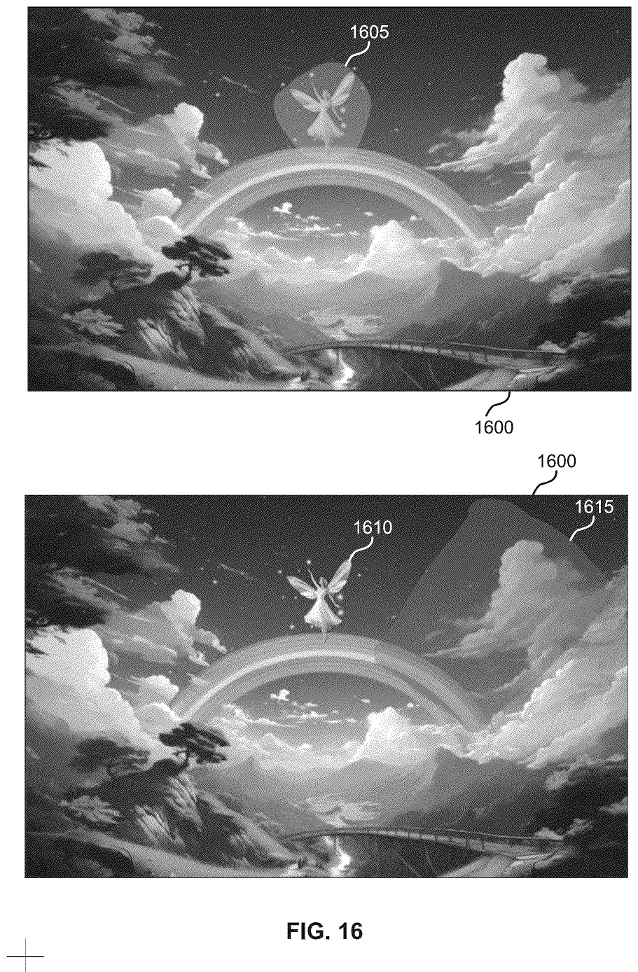

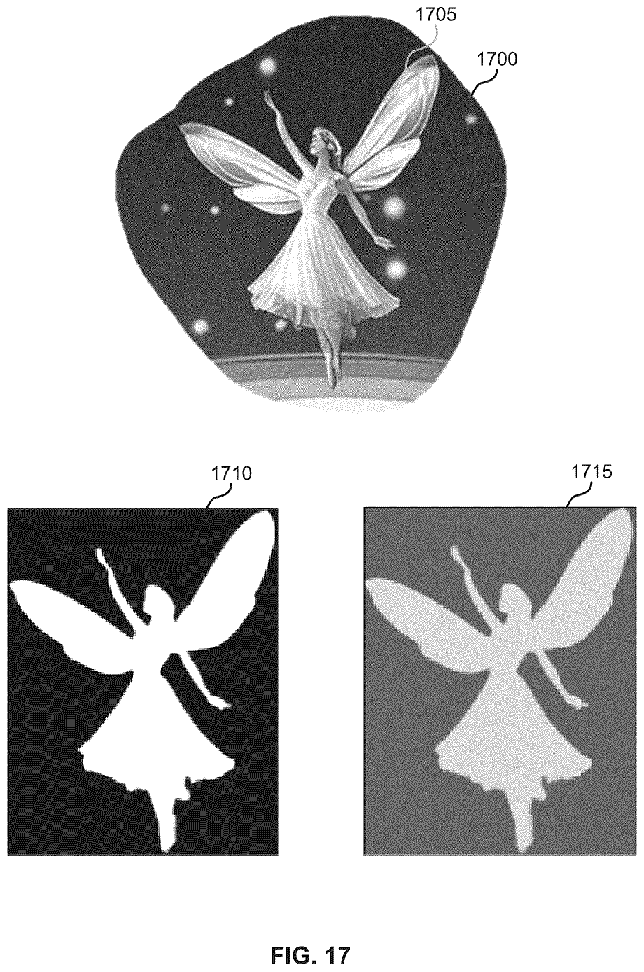

In an example shown in in FIG. 3, input image 305 depicts a bag and a bowl of coffee beans where a wooden spoon holding some coffee beans. Source region 310 is selected by a brush tool (hence the irregular shape). Source region 310 includes a wooden coffee spoon holding some coffee beans. Source object 315 is located within source region 310. The source object 315 is the wooden coffee spoon. Input image 305 is an example of, or includes aspects of, the corresponding element described with reference to FIGS. 4, 13, 14, 16, and 21. Source region 310 is an example of, or includes aspects of, the corresponding element described with reference to FIGS. 16 and 17. Source object 315 is an example of, or includes aspects of, the corresponding element described with reference to FIGS. 13, 16, 17, 21, and 22.

In some cases, cloning tool 320 is a clickable button located on the left panel of user interface 300. Clicking on cloning tool 320 initiates a generative image cloning process. A backend image generation model then performs image generation and object cloning. Cloning tool 320 is an example of, or includes aspects of, the corresponding element described with reference to FIGS. 4-6.

In the above example, the creativity parameter 325 is set to “High”. The spacing parameter 330 is set to “Sparse”. The style parameter 335 is set to “Match Original”. Creativity parameter 325 is an example of, or includes aspects of, the corresponding element described with reference to FIGS. 4-6, 21, and 22. Spacing parameter 330 is an example of, or includes aspects of, the corresponding element described with reference to FIGS. 4-6, 21, and 22. Style parameter 335 is an example of, or includes aspects of, the corresponding element described with reference to FIGS. 4-6.

In some cases, text prompt 340 is provided by user 100 and text prompt 340 serves as text guidance for image generation and object cloning (e.g., specifying an attribute or feature for the synthetic variant). In some cases, text prompt 340 is generated based on the source object 315. Here, text prompt 340 is left empty. Text prompt 340 is an example of, or includes aspects of, the corresponding element described with reference to FIGS. 4-6, and 15.

FIG. 4 shows an example of a user interface 400 for image processing and region selection according to aspects of the present disclosure. The example shown includes user interface 400, input image 405, target region 410, cloning tool 415, creativity parameter 420, spacing parameter 425, style parameter 430, text prompt 435, and information element 440. User interface 400 is an example of, or includes aspects of, the corresponding element described with reference to FIGS. 3, 5, 6, 8, 13-15, 21, and 22.

In an example as shown in FIG. 4, input image 405 depicts a bag and a bowl of coffee beans where a wooden spoon holding some coffee beans. Input image 405 is an example of, or includes aspects of, the corresponding element described with reference to FIGS. 3, 13, 14, 16, and 21.

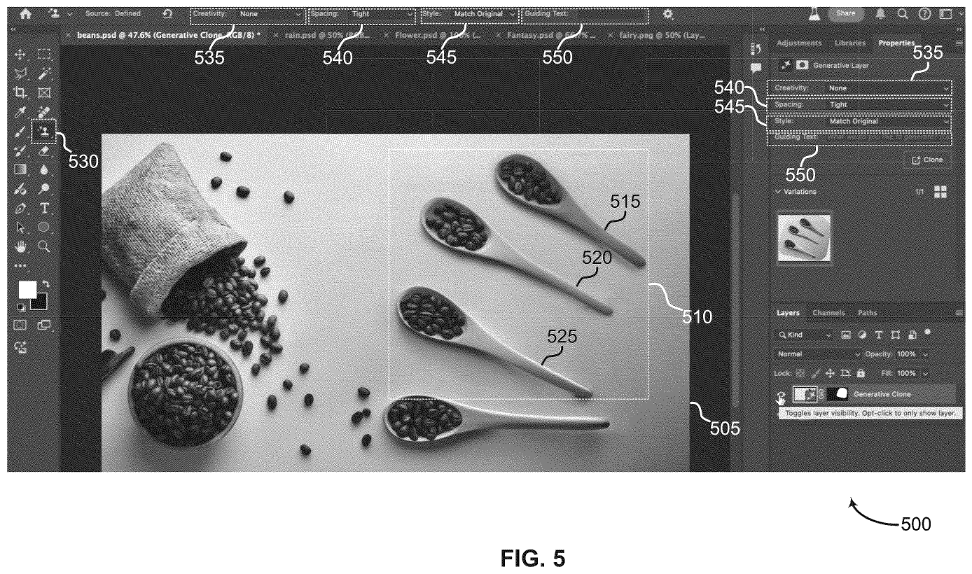

In some cases, target region 410 is located above a source object. Target region 410 may be selected by a selection preset (e.g., a circle, a rectangular), a bounding box, a brush tool (irregular shape), etc. The target region 410 has an irregular shape and is located above the wooden coffee spoon. Target region 410 is an example of, or includes aspects of, the corresponding element described with reference to FIGS. 5, 6, 14, 16, and 18.

In some cases, cloning tool 415 is a clickable button located on the left panel of user interface 400. Clicking on cloning tool 415 initiates a generative image cloning process. A backend image generation model then performs image generation and object cloning. Cloning tool 415 is an example of, or includes aspects of, the corresponding element described with reference to FIGS. 3, 5, and 6.

In the above example, the creativity parameter 420 is set to “None”, indicating the synthetic variant (to be generated) depicts a same object as the source object. The spacing parameter 425 is set to “Tight”. The style parameter 430 is set to “Match Original”. Creativity parameter 420 is an example of, or includes aspects of, the corresponding element described with reference to FIGS. 3, 5, 6, 21, and 22. Spacing parameter 425 is an example of, or includes aspects of, the corresponding element described with reference to FIGS. 3, 5, 6, 21, and 22. Style parameter 430 is an example of, or includes aspects of, the corresponding element described with reference to FIGS. 3, 5, and 6.

In some cases, text prompt 435 is provided by user 100 and text prompt 435 serves as text guidance for image generation and object cloning (e.g., specifying an attribute or feature for the synthetic variant). In some cases, text prompt 435 is generated based on the source object 315. Here, text prompt 435 is left empty. Text prompt 435 is an example of, or includes aspects of, the corresponding element described with reference to FIGS. 3, 5, 6, and 15.

Information element 440 is a pop-up notification box indicating that image generation is in progress, a progress bar indicating the generative progress, and a tip/guidance information for users. In the example shown, information element 440 includes a message “Generating” and the generative process is almost completed. The user guidance information reads “Tip: Experiment with different options from the toolbar to boost your creativity with generative cloning”.

FIG. 5 shows an example of a user interface 500 displaying objects with low creativity according to aspects of the present disclosure. The example shown includes user interface 500, output image 505, target region 510, cloning tool 530, creativity parameter 535, spacing parameter 540, style parameter 545, and text prompt 550. User interface 500 is an example of, or includes aspects of, the corresponding element described with reference to FIGS. 3, 4, 6, 8, 13-15, 21, and 22.

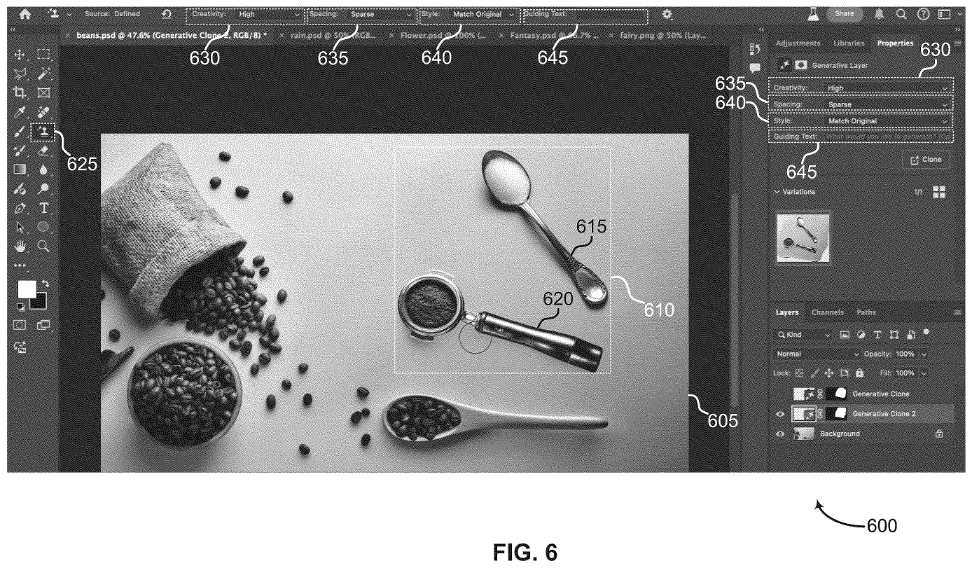

In an embodiment, output image 505 is generated using an image generation model 840 as described with reference to FIG. 8. The output image 505 is generated based on the source object, the selected parameters (e.g., creativity, spacing, style), and target region 510. In some examples, output image 505 includes a set of synthetic variants of the source object in target region 510. The output image 505 is generated based on creativity parameter 535, spacing parameter 540, style parameter 545, text prompt 550, or any combination thereof. By clicking on cloning tool 530, the system triggers image generation model 840 to perform image generation and object cloning. Output image 505 is an example of, or includes aspects of, the corresponding element described with reference to FIGS. 6, 13, 14, 16, and 21.

In an example as shown in in FIG. 5, output image 505 depicts a bag and a bowl of coffee beans where a wooden spoon holding some coffee beans. The output image 505 includes target region 510, which comprises a set of synthetic variants of the source object. In this example, output image 505 includes first synthetic object 515, second synthetic object 520, and third synthetic object 525.

The target region 510 includes first synthetic object 515, second synthetic object 520, and third synthetic object 525. The target region 510 is located above the source object 315. Target region 510 is an example of, or includes aspects of, the corresponding element described with reference to FIGS. 4, 6, 14, 16, and 18.

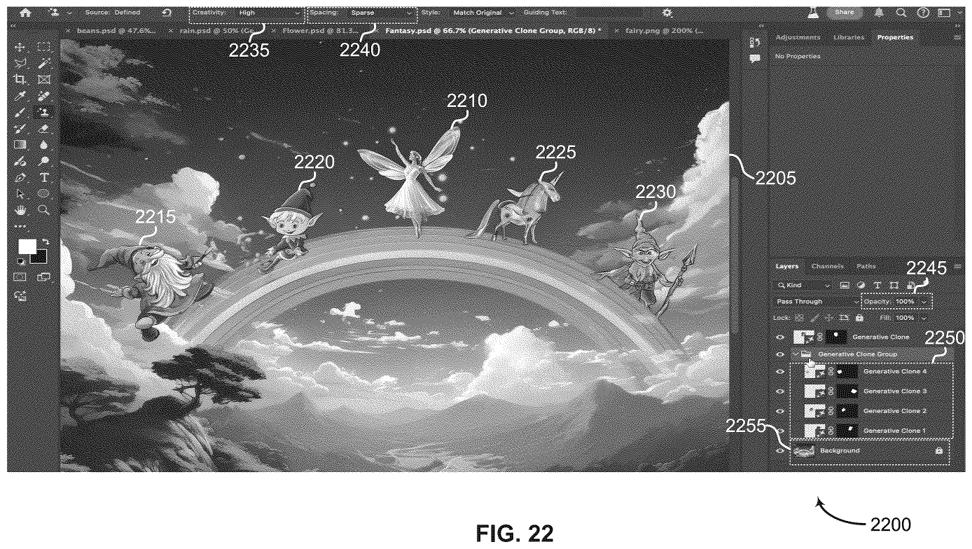

The first synthetic object 515, second synthetic object 520, and third synthetic object 525 depict a same object as source object 315 described with reference to FIG. 3, i.e., a wooden coffee spoon holding some coffee beans, because creativity parameter 535 is set to “None” (no creativity). First synthetic object 515 is an example of, or includes aspects of, the corresponding element described with reference to FIGS. 6 and 22. Second synthetic object 520 is an example of, or includes aspects of, the corresponding element described with reference to FIGS. 6 and 22. Third synthetic object 525 is an example of, or includes aspects of, the corresponding element described with reference to FIG. 22.

In some cases, cloning tool 530 is a clickable button located on the left panel of user interface 500. Clicking on cloning tool 530 initiates a generative image cloning process. A backend image generation model then performs image generation and object cloning. Cloning tool 530 is an example of, or includes aspects of, the corresponding element described with reference to FIGS. 3, 4, and 6.

Herein, creativity parameter 535 is set to “None”, which indicates the set of synthetic variants in output image 505 should depict a same object as source object 315. As such, first synthetic object 515, second synthetic object 520, and third synthetic object 525 are the same wooden coffee spoon. Creativity parameter 535 is an example of, or includes aspects of, the corresponding element described with reference to FIGS. 3, 4, 6, 21, and 22.

In the above example, spacing parameter 540 is set to “Tight”. As such, the first synthetic object 515, second synthetic object 520, and third synthetic object 525 are tightly spaced or arranged in target region 510 (e.g., less empty space). Spacing parameter 540 is an example of, or includes aspects of, the corresponding element described with reference to FIGS. 3, 4, 6, 21, and 22.

In the above example, style parameter 545 is set to “Match Original”. As such, the first synthetic object 515, second synthetic object 520, and third synthetic object 525 in output image 505 match the original style of source object 315. Style parameter 545 is an example of, or includes aspects of, the corresponding element described with reference to FIGS. 3, 4, and 6.

In some cases, text prompt 550 is provided by user 100 and text prompt 550 serves as text guidance for image generation and object cloning (e.g., specifying an attribute or feature for the synthetic variant). In some cases, text prompt 550 is generated based on the source object 315. Here, text prompt 550 is left empty. Text prompt 550 is an example of, or includes aspects of, the corresponding element described with reference to FIGS. 3, 4, 6, and 15.

FIG. 6 shows an example of a user interface 600 displaying objects with high creativity according to aspects of the present disclosure. The example shown includes user interface 600, output image 605, target region 610, cloning tool 625, creativity parameter 630, spacing parameter 635, style parameter 640, and text prompt 645. User interface 600 is an example of, or includes aspects of, the corresponding element described with reference to FIGS. 3-5, 8, 13-15, 21, and 22.

In an embodiment, output image 605 is generated using an image generation model 840 as described with reference to FIG. 8. The output image 605 is generated based on the source object, the selected parameters (e.g., creativity, spacing, style), and target region 610. In some examples, output image 605 includes a set of synthetic variants of the source object in target region 610. The output image 605 is generated based on creativity parameter 630, spacing parameter 635, style parameter 640, text prompt 645, or any combination thereof. By clicking on cloning tool 625, the system triggers image generation model 840 to perform image generation and object cloning. Output image 605 is an example of, or includes aspects of, the corresponding element described with reference to FIGS. 5, 13, 14, 16, and 21.

In an example as shown in in FIG. 6, output image 605 depicts a bag and a bowl of coffee beans where a wooden spoon holding some coffee beans. The output image 605 includes target region 610, which comprises a set of synthetic variants of the source object. In this example, output image 605 includes first synthetic object 615 and second synthetic object 620.

The target region 610 includes first synthetic object 615 and second synthetic object 620. The target region 610 is located above the source object 315. Target region 610 is an example of, or includes aspects of, the corresponding element described with reference to FIGS. 4, 5, 14, 16, and 18.

The first synthetic object 615 depicts a steel spoon holding ground coffee. The second synthetic object 620 depicts a steel spoon holding sugar. The first synthetic object 615 and second synthetic object 620 look different from source object 315 because creativity parameter 630 is set to “High” (high creativity). First synthetic object 615 is an example of, or includes aspects of, the corresponding element described with reference to FIGS. 5 and 22. Second synthetic object 620 is an example of, or includes aspects of, the corresponding element described with reference to FIGS. 5 and 22.

In some cases, cloning tool 625 is a clickable button located on the left panel of user interface 600. Clicking on cloning tool 625 initiates a generative image cloning process. A backend image generation model then performs image generation and object cloning. Cloning tool 625 is an example of, or includes aspects of, the corresponding element described with reference to FIGS. 3-5.

In the above example, creativity parameter 630 is set to “High”, which indicates the set of synthetic variants in output image 605 should depict different objects from source object 315. The first synthetic object 615 and the second synthetic object 620 look different from source object 315. Creativity parameter 630 is an example of, or includes aspects of, the corresponding element described with reference to FIGS. 3-5, 21, and 22.

In the above example, the spacing parameter 635 is set to “Sparse”. As such, the first synthetic object 615 and second synthetic object 620 are arranged in a sparse manner in target region 610 (e.g., more empty space). Spacing parameter 635 is an example of, or includes aspects of, the corresponding element described with reference to FIGS. 3-5, 21, and 22.

In the above example, style parameter 640 is set to “Match Original.” As such, the first synthetic object 615 and second synthetic object 620 in output image 605 match the original style of source object 315 (e.g., a spoon holding some edible). Style parameter 640 is an example of, or includes aspects of, the corresponding element described with reference to FIGS. 3-5.

In some cases, text prompt 645 is provided by user 100 and text prompt 645 serves as text guidance for image generation and object cloning (e.g., specifying an attribute or feature for the synthetic variant). In some cases, text prompt 645 is generated based on the source object 315. Here, text prompt 645 is left empty. Text prompt 645 is an example of, or includes aspects of, the corresponding element described with reference to FIGS. 3-5, and 15.

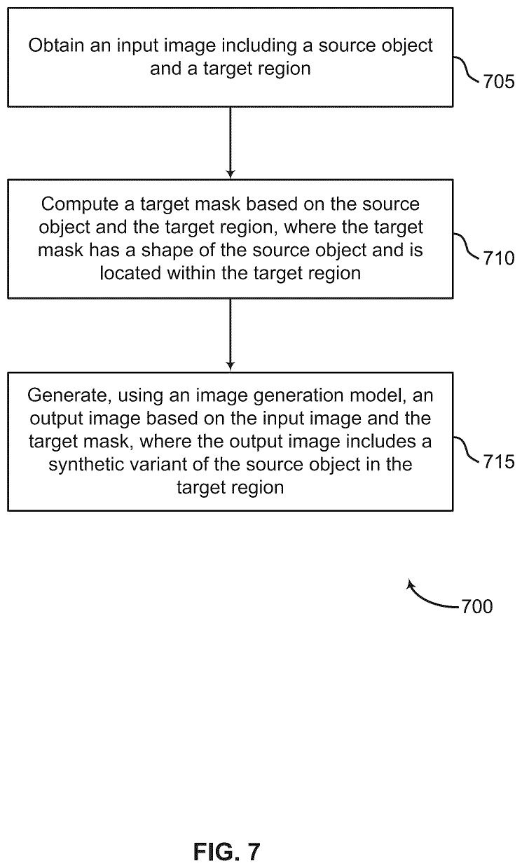

FIG. 7 shows an example of a method 700 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 705, the system obtains an input image including a source object and a target region. In some cases, the operations of this step refer to, or may be performed by, a user interface as described with reference to FIGS. 3-6, 8, 13-15, 21, and 22. According to an embodiment, the system obtains the source object from the input image. Alternatively, the system obtains the source object from another document different from the input image. In some cases, a user selects a source region from the input image or another document, e.g., via a brush tool. In some cases, the user adds one or more source regions or modifies the marked (selected) source region.

At operation 710, the system computes a target mask based on the source object and the target region, where the target mask has a shape of the source object and is located within the target region. In some cases, the operations of this step refer to, or may be performed by, an image generation model as described with reference to FIG. 8. In some cases, the system performs region-analysis to understand the source object from the source region, for example using a language generation model. A language generation model (described with reference to FIG. 8) includes a language processing model such as vLLM, Llava or internVL based visual large language model (LLM). The language generation model is used to understand the source object efficiently and facilitates generation of synthetic variations of the source object in subsequent operations. In some cases, the language generation model generates textual creative variations of the source object to facilitate subsequent operations. In some cases, the language generation model performs region analysis based on a creativity parameter. The creativity parameter refers to a degree of creativity set by the user.

In an embodiment, the system performs a set of computations based on image cloning parameters and the target region. The image generation model calculates one or more bounding boxes for one or more synthetic variants and calculates one or more masks corresponding to the one or more bounding boxes for generative fill”. “Synthetic variants” refer to one or more additional objects to be generated and positioned in the target region. In some cases, “generative fill” refers to a process of generating the one or more synthetic variants and placing the one or more synthetic variants inside the one or more bounding boxes based on the one or more masks. In some cases, prior to performing the set of computations, the system sets brush parameters of a generative clone tool based on the source region. The set of computations transforms an object mask based on the target region.

At operation 715, the system generates, using an image generation model, an output image based on the input image and the target mask, where the output image includes a synthetic variant of the source object in the target region. In some cases, the operations of this step refer to, or may be performed by, an image generation model as described with reference to FIG. 8. In some examples, the image generation model generates an output image that includes a set of synthetic variants of the source object. The set of synthetic variants may look different from one another. In some examples, the set of synthetic variants look similar or identical to one another.

In an embodiment, the image generation model enables cloning to happen from a source region to a destination region in creative fashion, i.e., enables the source region “variations” to be pasted on the destination region based on options selected by users. For example, users may specify one or more parameters in the options bar of an object cloning tool which runs the image generation model on the backend. The options include creativity level, spacing required, transformation, etc.

Different form blindly copying the source region to the destination region in the input image, the image generation model may modify the source region based on the destination region's surrounding content before pasting it to the destination (target) region. In some cases, the source region is from the same input image (maintain the overall scene environment such as lighting from the source region to the destination region. In some other cases, the source region is from a different image other than the input image, i.e., obtain a source region from any image (not necessarily the input image). The image generation model can adjust the source region based on the destination region depending on various user preferences.

The cloning tool is also referred to as a generative clone tool which enables users to select a source region in the same document or any other document and then cloning it on the destination region with creative variations. Details are described in at least FIGS. 3-6. In some embodiments, the generative clone tool incorporates a cloning tool, a back-end large language model (LLM), a back-end image generation model (e.g., stable diffusion model, diffusion transformer) at the back end, and transformation algorithms to generate synthetic outputs (clone version of an original object) based on user selected parameters from the tool options.

In an embodiment, a machine learning model (described with reference to FIG. 8) extracts the source region from same document or other document as a reference data. The machine learning model interprets the objects within the reference data using a language generation model (e.g., vLLM). The language generation model generates textual creative variations of the objects analyzed in previous step. The machine learning model performs mask transformation and clone brush parameters assignment. In some examples, the machine learning model sets brush parameters of the generative clone tool based on the source region as well as transforming the object mask based on the destination region. The machine learning model performs conversion of destination masks with auto computed opacity. The image generation model takes a text prompt (textual creative variations of the objects) and transformed object mask as input. In some cases, the step about mask transformation and clone brush parameters assignment and the step about conversion of destination masks with auto-computed opacity are repeated based on a spacing parameter.

In FIGS. 1-7, a method, apparatus, non-transitory computer readable medium, and system for media processing are described. One or more aspects of the method, apparatus, non-transitory computer readable medium, and system include obtaining an input image including a source object and a target region; computing a target mask based on the source object and the target region, where the target mask has a shape of the source object and is located within the target region; and generating, using an image generation model, an output image based on the input image and the target mask, where the output image includes a synthetic variant of the source object in the target region.

Some examples of the method, apparatus, non-transitory computer readable medium, and system further include obtaining a creativity parameter that indicates a degree of similarity between the source object and the synthetic variant, where the output image is generated based on the creativity parameter.

Some examples of the method, apparatus, non-transitory computer readable medium, and system further include extracting a source mask corresponding to the source object from the input image, where the target mask is based on the source mask.

Some examples of the method, apparatus, non-transitory computer readable medium, and system further include dividing the target region into a set of cloning regions, where the target mask is located within one of the set of cloning regions, and where the output image includes a set of synthetic variants corresponding to the set of cloning regions.

Some examples of the method, apparatus, non-transitory computer readable medium, and system further include obtaining a spacing parameter, where the target region is divided based on the spacing parameter.

Some examples of the method, apparatus, non-transitory computer readable medium, and system further include obtaining a target transformation that indicates a rotation of the source object, where the target mask is computed based on the target transformation.

Some examples of the method, apparatus, non-transitory computer readable medium, and system further include obtaining a text prompt that indicates an attribute of the synthetic variant, where the output image is generated based on the text prompt. In some examples, the text prompt is generated based on the source object.

Some examples of the method, apparatus, non-transitory computer readable medium, and system further include obtaining an opacity parameter indicating a level of opacity for the synthetic variant, where the target mask is generated based on the opacity parameter.

Some examples of the method, apparatus, non-transitory computer readable medium, and system further include obtaining a style parameter indicating a style attribute for the synthetic variant, where the output image is generated based on the style parameter.

### Network Architecture

FIG. 8 shows an example of an image processing apparatus 800 according to aspects of the present disclosure. The example shown includes image processing apparatus 800, processor unit 805, I/O module 810, user interface 815, memory unit 820, and training component 845. Image processing apparatus 800 is an example of, or includes aspects of, the corresponding element described with reference to FIG. 1. User interface 815 is an example of, or includes aspects of, the corresponding element described with reference to FIGS. 3-6, 13-15, 21, and 22.

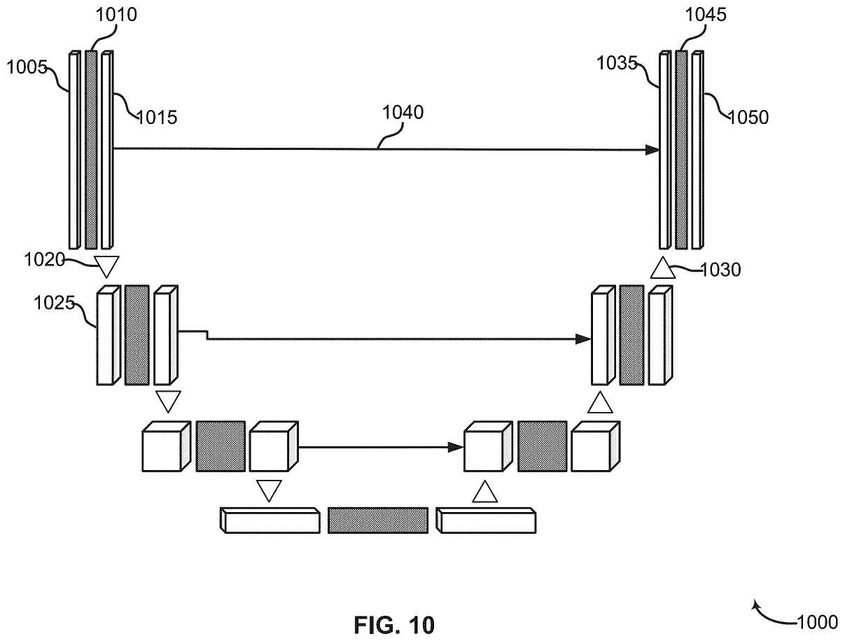

Image processing apparatus 800 may include an example of, or aspects of, the guided diffusion model described with reference to FIG. 9, the U-Net described with reference to FIG. 10, and/or the diffusion transformer described with reference to FIG. 12. In some embodiments, image processing apparatus 800 includes processor unit 805, I/O module 810, user interface 815, memory unit 820, machine learning model 825, and training component 845. Training component 845 updates parameters of the machine learning model 825 stored in memory unit 820. In some examples, the training component 845 is implemented in an apparatus external to image processing apparatus 800.

Processor unit 805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

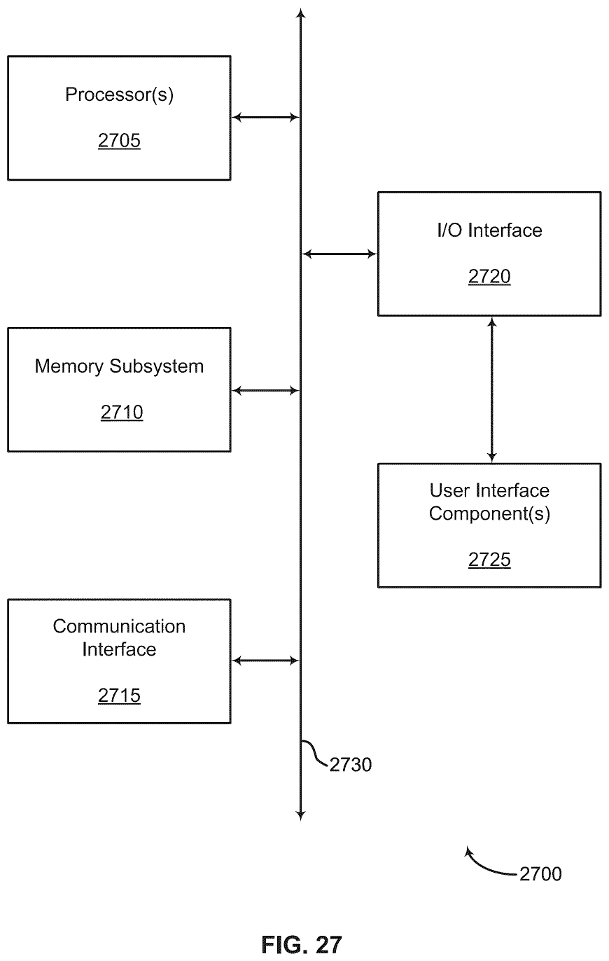

In some cases, processor unit 805 is configured to operate a memory array using a memory controller. In other cases, a memory controller is integrated into processor unit 805. In some cases, processor unit 805 is configured to execute computer-readable instructions stored in memory unit 820 to perform various functions. In some aspects, processor unit 805 includes special purpose components for modem processing, baseband processing, digital signal processing, or transmission processing. According to some aspects, processor unit 805 comprises one or more processors described with reference to FIG. 27.

Memory unit 820 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 805 to perform various functions described herein.

In some cases, memory unit 820 includes a basic input/output system (BIOS) that controls basic hardware or software operations, such as an interaction with peripheral components or devices. In some cases, memory unit 820 includes a memory controller that operates memory cells of memory unit 820. For example, the memory controller may include a row decoder, column decoder, or both. In some cases, memory cells within memory unit 820 store information in the form of a logical state. According to some aspects, memory unit 820 is an example of the memory subsystem 2710 described with reference to FIG. 27.

According to some aspects, image processing apparatus 800 uses one or more processors of processor unit 805 to execute instructions stored in memory unit 820 to perform functions described herein. For example, image processing apparatus 800 may obtain an input image including a source object and a target region; compute a target mask based on the source object and the target region, where the target mask has a shape of the source object and is located within the target region; and generate, using an image generation model 840, an output image based on the input image and the target mask, where the output image includes a synthetic variant of the source object in the target region.

According to some aspects, memory unit 820 includes a memory component. In one aspect, memory unit 820 includes machine learning model 825 trained to obtain an input image including a source object and a target region; compute a target mask based on the source object and the target region, where the target mask has a shape of the source object and is located within the target region; and generate, using image generation model 840, an output image based on the input image and the target mask, where the output image includes a synthetic variant of the source object in the target region. For example, after training, the machine learning model 825 may perform inferencing operations as described with reference to FIGS. 2 and 7.

In some embodiments, machine learning model 825 is an artificial neural network (ANN) such as the guided diffusion model described with reference to FIG. 9, the U-Net described with reference to FIG. 10, or the diffusion transformer described with reference to FIG. 12. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 825 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

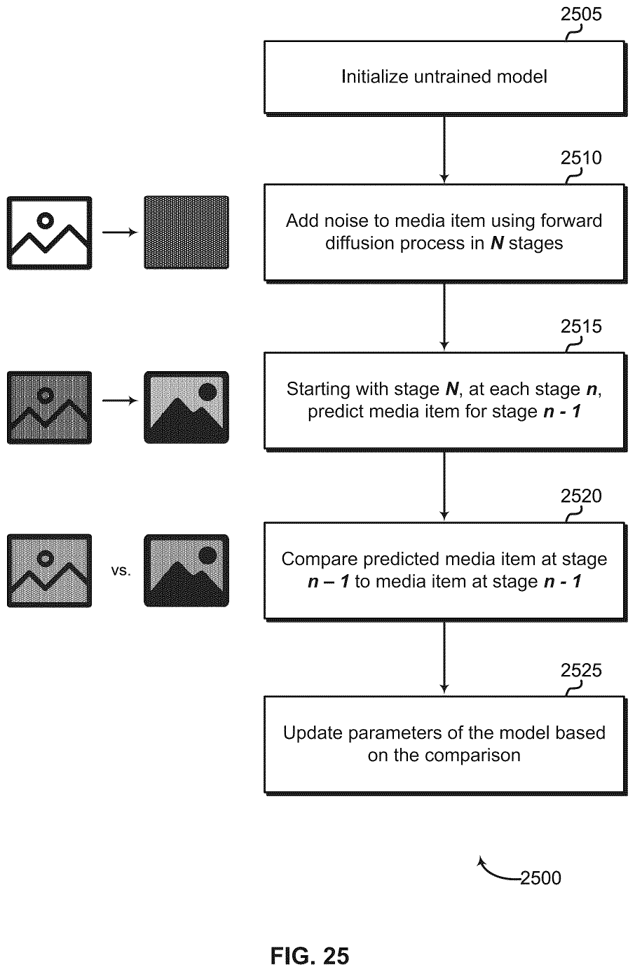

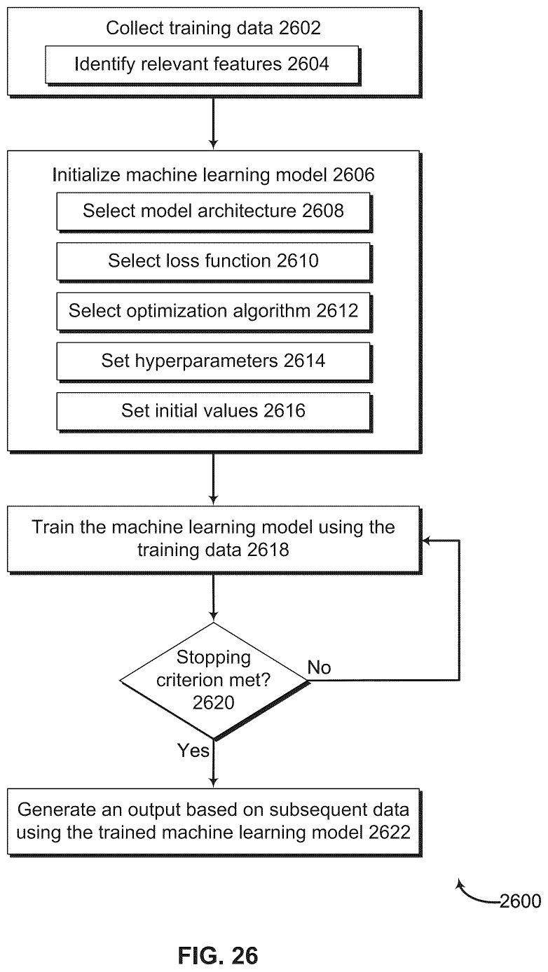

Training component 845 may train the machine learning model 825. For example, parameters of the machine learning model 825 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 25-26). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 825 can be used to make predictions on new, unseen data (i.e., during inference).

I/O module 810 receives inputs from and transmits outputs of the image processing apparatus 800 to other devices or users. For example, I/O module 810 receives inputs for the machine learning model 825 and transmits outputs of the machine learning model 825. According to some aspects, I/O module 810 is an example of the I/O interface 2720 described with reference to FIG. 27.

According to some embodiments, machine learning model 825 obtains an input image including a source object and a target region. Image generation model 840 computes a target mask based on the source object and the target region, where the target mask has a shape of the source object and is located within the target region. Image generation model 840 generates an output image based on the input image and the target mask, where the output image includes a synthetic variant of the source object in the target region.

In some examples, user interface 815 obtains a creativity parameter that indicates a degree of similarity between the source object and the synthetic variant, where the output image is generated based on the creativity parameter. In some examples, user interface 815 obtains a spacing parameter, where the target region is divided based on the spacing parameter. In some examples, user interface 815 obtains a style parameter indicating a style attribute for the synthetic variant, where the output image is generated based on the style parameter. In some examples, user interface 815 obtains an opacity parameter indicating a level of opacity for the synthetic variant, where the target mask is generated based on the opacity parameter.

In some examples, machine learning model 825 obtains a creativity parameter that indicates a degree of similarity between the source object and the set of synthetic variants, where the output image is generated based on the creativity parameter.

In some examples, image generation model 840 extracts a source mask corresponding to the source object from the input image, where the target mask is based on the source mask. In some examples, image generation model 840 divides the target region into a set of cloning regions, where the target mask is located within one of the set of cloning regions, and where the output image includes a set of synthetic variants corresponding to the set of cloning regions. In some examples, image generation model 840 obtains a target transformation that indicates a rotation of the source object, where the target mask is computed based on the target transformation.

In some examples, language generation model 835 obtains a text prompt that indicates an attribute of the synthetic variant, where the output image is generated based on the text prompt. In some examples, the text prompt is generated based on the source object. In some examples, language generation model 835 is configured to generate a text prompt indicating an attribute of the synthetic variant based on the source object. In some examples, language generation model 835 is a vLLM (e.g., Llava and internVL based visual LLM), but is not limited to vLLM. Here, LLM is short for large language model.

According to some embodiments, image generation model 840 generates an output image based on the input image and the set of cloning regions, where the output image includes a set of synthetic variants of the source object corresponding to the set of cloning regions.

In some examples, image generation model 840 computes a set of target masks corresponding to the set of cloning regions, respectively, where each of the set of target masks has a shape of the source object. The output image is generated based on the set of target masks.

In some examples, image generation model 840 obtains a target transformation that indicates a rotation of the source object, where the set of target masks are computed based on the target transformation. In some cases, language generation model 835 obtains a text prompt that indicates an attribute of each of the set of synthetic variants, respectively, where the output image is generated based on the text prompt.

In one embodiment, machine learning model 825 includes transformation component 830, language generation model 835, and image generation model 840.

Transformation component 830 divides the target region into a set of cloning regions, where the target mask is located within one of the set of cloning regions. The output image includes a set of synthetic variants corresponding to the set of cloning regions. In some examples, transformation component 830 obtains a target transformation that indicates a rotation of the source object, where the target mask is computed based on the target transformation.

According to an embodiment, transformation component 830 computes a target transformation that indicates a rotation of the source object, where the target mask is computed based on the target transformation.

FIG. 9 shows an example of a guided diffusion model according to aspects of the present disclosure. The guided latent diffusion model 900 depicted in FIG. 9 is an example of, or includes aspects of, the corresponding element (i.e., image generation model 840) described with reference to FIG. 8.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 900 may take an original image 905 in a pixel space 910 as input and apply and image encoder 915 to convert original image 905 into original image features 920 in a latent space 925. Then, a forward diffusion process 930 gradually adds noise to the original image features 920 to obtain noisy features 935 (also in latent space 925) at various noise levels.

Next, a reverse diffusion process 940 (e.g., a U-Net ANN described in FIG. 10 or a diffusion transformer described with reference to FIG. 12) gradually removes the noise from the noisy features 935 at the various noise levels to obtain denoised image features 945 in latent space 925. In some examples, the denoised image features 945 are compared to the original image features 920 at each of the various noise levels, and parameters of the reverse diffusion process 940 of the diffusion model are updated based on the comparison. Finally, an image decoder 950 decodes the denoised image features 945 to obtain an output image 955 in pixel space 910. In some cases, an output image 955 is created at each of the various noise levels. The output image 955 can be compared to the original image 905 to train the reverse diffusion process 940.

In some cases, image encoder 915 and image decoder 950 are pre-trained prior to training the reverse diffusion process 940. In some examples, image encoder 915 and image decoder 950 are trained jointly, or the image encoder 915 and image decoder 950 and fine-tuned jointly with the reverse diffusion process 940.

The reverse diffusion process 940 can also be guided based on a text prompt 960, or another guidance prompt, such as an image, a layout, a segmentation map, etc. The text prompt 960 can be encoded using a text encoder 965 (e.g., a multimodal encoder) to obtain guidance features 970 in guidance space 975. The guidance features 970 can be combined with the noisy features 935 at one or more layers of the reverse diffusion process 940 to ensure that the output image 955 includes content described by the text prompt 960. For example, guidance features 970 can be combined with the noisy features 935 using a cross-attention block within the reverse diffusion process 940.

FIG. 10 shows an example of a U-Net 1000 architecture according to aspects of the present disclosure. In some examples, U-Net 1000 is an example of the component that performs the reverse diffusion process 940 of guided latent diffusion model 900 described with reference to FIG. 9. The U-Net 1000 depicted in FIG. 10 is an example of, or includes aspects of, the architecture used within the reverse diffusion process described with reference to FIG. 9.

In some examples, diffusion models are based on a neural network architecture known as a U-Net. The U-Net 1000 takes input features 1005 having an initial resolution and an initial number of channels and processes the input features 1005 using an initial neural network layer 1010 (e.g., a convolutional network layer) to produce intermediate features 1015. The intermediate features 1015 are then down-sampled using a down-sampling layer 1020 such that down-sampled features 1025 have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having the same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features could include a vector representation of an input prompt. The additional input features can be combined with the intermediate features 1015 within the neural network at one or more layers. For example, a cross-attention module can be used to combine the additional input features and the intermediate features 1015.

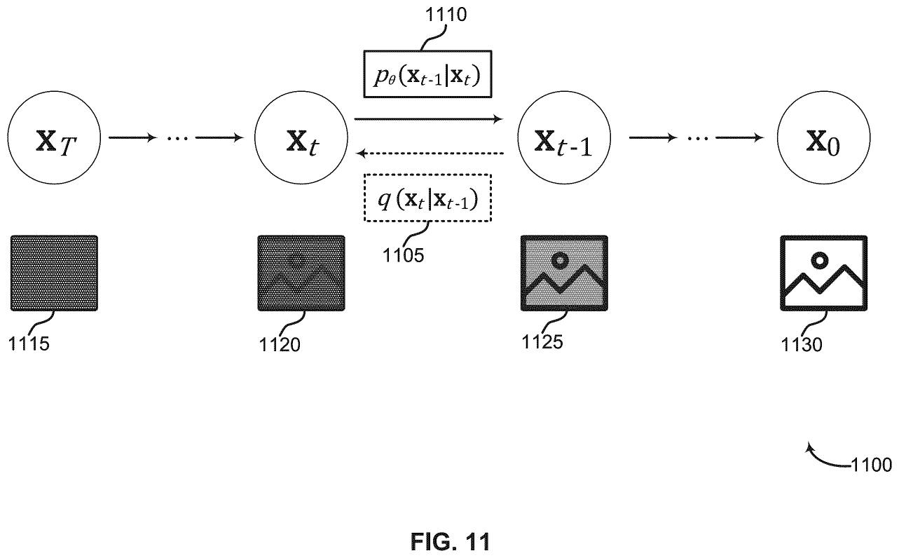

FIG. 11 shows an example of a diffusion process 1100 according to aspects of the present disclosure. In some examples, diffusion process 1100 describes an operation of the image generation model 840 described with reference to FIG. 8, such as the reverse diffusion process 940 of guided latent diffusion model 900 described with reference to FIG. 9.

As described above with reference to FIGS. 9 and 11, using a diffusion model can involve both a forward diffusion process 1105 for adding noise to a media item (or features in a latent space) and a reverse diffusion process 1110 for denoising the media item (or features) to obtain a denoised media item. The forward diffusion process 1105 can be represented as q(xₜ|xₜ₋₁), and the reverse diffusion process 1110 can be represented as p_{θ}(xₜ₋₁|xₜ), where θ represents some trainable parameters. In some cases, the forward diffusion process 1105 is used during training to generate media items with successively greater noise, and a neural network is trained to perform the reverse diffusion process 1110 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net 1000 as described with reference to FIG. 10, where x₁, . . . , x_{T} have the same dimensionality as x₀.

The neural network may be trained to perform the reverse process. During the reverse diffusion process 1110, the model begins with noisy data x_{T}, such as a noisy media item 1115 and denoises the data to obtain the p (xₜ₋₁|xₜ). At each step t−1, the reverse diffusion process 1110 takes xₜ, such as first intermediate media item 1120, and t as input. Here, t represents a step in the sequence of transitions associated with different noise levels, The reverse diffusion process 1110 outputs xₜ₋₁, such as second intermediate media item 1125 iteratively until x-reverts back to x₀, the original media item 1130. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x)=N(x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality.

FIG. 12 shows an example of a diffusion transformer according to aspects of the present disclosure. The example shown includes predicted noise 1205, predicted covariance 1210, linear and reshape layers 1215, normalization layer 1220, DiT block(s) 1225, patchify operation 1230, embedding 1235, noised latent 1240, timestep information 1245, label information 1250, and an implementation of one block in the DiT block(s) 1225 by a DiT block 1296. The DiT block 1296 includes: second residual connection 1260, second scaling operations 1262, feed-forward network 1264, post-normalization second scaling and shifting 1266, second normalization 1268, first residual connection 1270, first scaling operations 1272, self-attention 1274, post-normalization first scaling and shifting 1276, first normalization 1278, input tokens 1280, conditioning tokens 1282, multi-layer perceptron (MLP) 1284, post-normalization first scaling and shifting parameters 1286, first scaling parameter 1288, post-normalization second scaling and shifting parameters 1290, and second scaling parameter 1292. In some embodiments, the architecture employes an latent diffusion transformer 1294. In some embodiments, DiT block 1296 employs an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks. Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, where a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The DiT architecture, in some cases, employs a latent diffusion transformer 1294. The DiT architecture processes noised latent 1240, which may be a noised version of an input image encoded in a latent space. Patchify operation 1230 divides the noised latent into a sequence of patches that are processed as tokens. The tokens are vector representations of each patch of the image in latent space and are adjusted through attention processes. Each of the tokens also receives timestep information 1245 and label information 1250 and, accordingly, embedding 1235 of timestep information 1245 and label information 1250, which encodes the current denoising timestep and class labels as conditional information. In some cases, embedding 1235 is referred to as conditional embedding or conditional information embedding. In some cases, a positional embedding which encodes each token's spatial position in the image is applied to the patchified input tokens at the patchify operations 1230. In some examples the positional embedding is ViT frequency-based positional embedding. The input tokens 1280 generated by the patchify operation 1230 and the conditioning tokens 1282 generated by the embedding 1235 are processed through N DiT block(s) 1225, where N may be 12, 24 or 28. Other values of N may be used. In some cases, conditional tokens refer to tokens generated based on embedding 1235 encoding timestep information 1245 and label information 1250.

Each of the DiT block(s) 1225 includes multiple processing stages. DiT block 1296 illustrates an embodiment of one block in the DiT block(s) 1225. In some embodiments, the DiT block 1296 is an example of, or includes aspects of, the adaLN-Zero block. In some cases, input tokens 1280 interact with the conditioning tokens 1282 through multiple attention mechanisms. Particularly, after first normalization 1278 applied to the input tokens and MLP 1284 to the conditional tokens, MLP 1284 generates or updates post-normalization first scaling and shifting parameters 1286, denoted as γ₁, β₁, for post-normalization first scaling and shifting 1276 to scale and shift the output of first normalization 1278 accordingly. As the normalized input tokens obtained from first normalization 1278 are scaled and shifted at post-normalization first scaling and shifting 1276 using the conditional information carried as least in γ₁, β₁, this allows the input information and conditional information to interact. Self-attention 1274 allows the scaled and shifted normalized input tokens, namely the output from post-normalization first scaling and shifting 1276, to attend to each other. MLP 1284 also generates or updates first scaling parameter 1288 denoted as α₁ for first scaling operations 1272 to scale the output of self-attention 1274 (e.g., multi-head self-attention), further interacting the input information and conditional information. The input tokens 1280 is then summed with the output of first scaling operations 1272 at first residual connection 1270. In some examples, α₁ has initial values 0, and the DiT block 1296 is initialized as the identity function.

A similar process is performed in a second half of the DiT block 1296. MLP 1284 generates or updates post-normalization second scaling and shifting parameters 1290, denoted as γ₂, β₂, for post-normalization second scaling and shifting 1266 to scale and shift the output of second normalization 1268 accordingly. As the output from second normalization 1268 is scaled and shifted using the conditional information carried at least in γ₂, β₂, this allows the input information and conditional information to further interact. Feed-forward network 1264 then processes the scaled and shifted output from post-normalization second scaling and shifting 1266. MLP 1284 also generates or updates second scaling parameter 1292 denoted as α₂ for second scaling operations 1262 to scale the output of feed-forward network 1264, further interacting the input information and conditional information. In some cases, the feed-forward network 1264 is a pointwise feed-forward network. The output from first residual connection 1270 is then summed with the output of second scaling operations 1262 at second residual connection 1260, and the result is the final output of DiT block 1296. In some examples, α₂ has initial values 0, and the DiT block 1296 is initialized as the identity function. This process repeats for each DiT block in the sequence.

After processing through all DiT block(s) 1225, the outputs undergo normalization layer 1220 followed by linear and reshape layers 1215. The final output is the predicted noise 1205, which represents the model's prediction of the noise that was added to initially create the noised latent 1240, and the predicted covariance 1210, which represents the model's prediction of the covariance. The predicted noise 1205 is removed from noised latent 1240 at each diffusion timestep, and the predicted covariance may affect how noise is removed or resampled in the reverse or denoising process. At the end of the denoising schedule, the latent sample is decoded to generate the synthetic image in pixel space.

In FIGS. 8-12, a method, apparatus, non-transitory computer readable medium, and system for media processing are described. One or more embodiments of the method, apparatus, non-transitory computer readable medium, and system include a memory component; a processing device coupled to the memory component, the processing device configured to perform operations comprising: obtaining an input image including a source object and a target region; computing a target mask based on the source object and the target region, where the target mask has a shape of the source object and is located within the target region; and generating, using an image generation model, an output image based on the input image and the target mask, where the output image includes a synthetic variant of the source object in the target region.

Some examples of the apparatus, system, and method further include a language generation model configured to generate a text prompt indicating an attribute of the synthetic variant based on the source object.

Some examples of the apparatus, system, and method further include a user interface configured to obtain a creativity parameter, a spacing parameter, a style parameter, an opacity parameter, or any combination thereof.

Some examples of the apparatus, system, and method further include a transformation component configured to compute a target transformation that indicates a rotation of the source object, where the target mask is computed based on the target transformation.

### Generative Image Cloning

FIG. 13 shows an example of a user interface 1300 including an opacity parameter 1315 according to aspects of the present disclosure. The example shown includes user interface 1300, input image 1305, source object 1310, and opacity parameter 1315. User interface 1300 is an example of, or includes aspects of, the corresponding element described with reference to FIGS. 3-6, 8, 14, 15, 21, and 22.

In an example shown in FIG. 13, user interface 1300 displays input image 1305 including source object 1310. The source object 1310 depicts an angel figure. The opacity parameter 1315 is located on the right-hand panel of user interface 1300. By setting a value for the opacity parameter 1315, source object 1310 is associated with a level of opacity based on the value for the opacity parameter 1315.

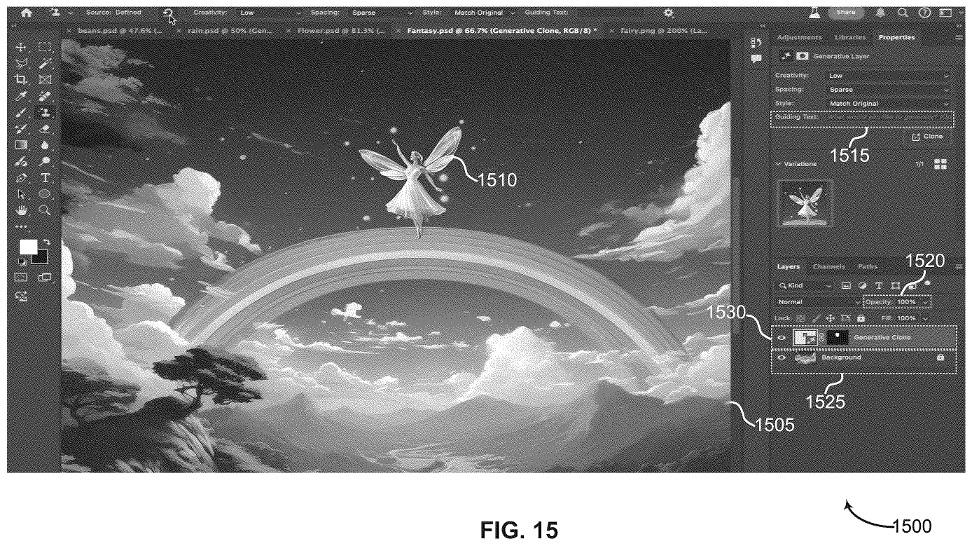

Input image 1305 is an example of, or includes aspects of, the corresponding element described with reference to FIGS. 3-6, 14, 16, and 21. Source object 1310 is an example of, or includes aspects of, the corresponding element described with reference to FIGS. 3, 16, 17, 21, and 22. Opacity parameter 1315 is an example of, or includes aspects of, the corresponding element described with reference to FIGS. 15 and 22. In the example shown, the opacity parameter 1315 is 100%.

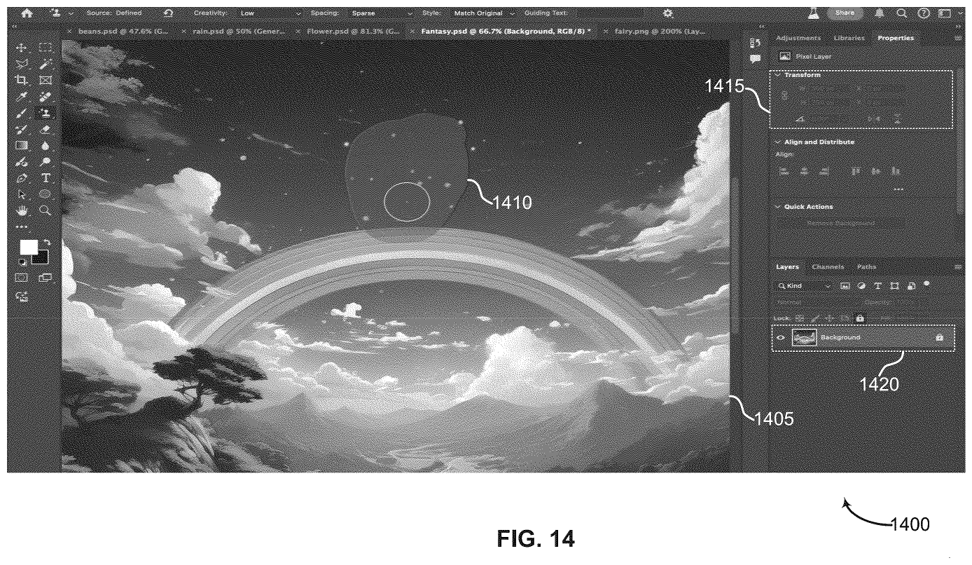

FIG. 14 shows an example of a user interface 1400 displaying a selected region according to aspects of the present disclosure. The example shown includes user interface 1400, input image 1405, target region 1410, transformation panel 1415, and background layer 1420. User interface 1400 is an example of, or includes aspects of, the corresponding element described with reference to FIGS. 3-6, 8, 13, 15, 21, and 22.

In some examples, target region 1410 is selected by user 100 using a brush tool. One or more synthetic objects are to be generated in target region 1410. Transformation panel 1415 and background layer 1420 are located on the right-hand panel of user interface 1400. A media output file is a layered file including background layer 1420. Background layer 1420 corresponds to input image 1405.

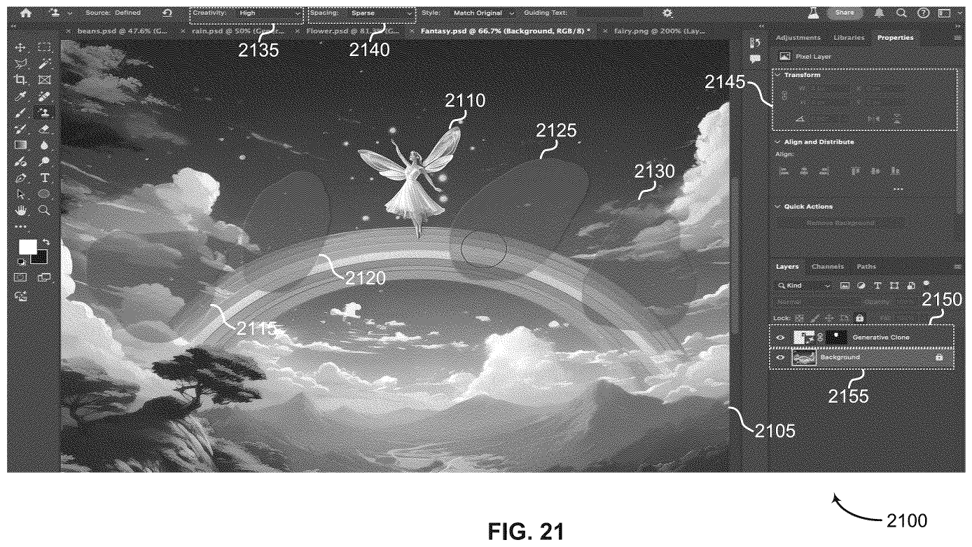

Input image 1405 is an example of, or includes aspects of, the corresponding element described with reference to FIGS. 3-6, 13, 16, and 21. Target region 1410 is an example of, or includes aspects of, the corresponding element described with reference to FIGS. 4-6, 16, and 18. Transformation panel 1415 is an example of, or includes aspects of, the corresponding element described with reference to FIG. 21. Background layer 1420 is an example of, or includes aspects of, the corresponding element described with reference to FIGS. 15, 21, and 22.

FIG. 15 shows an example of a user interface 1500 displaying an output image 1505 according to aspects of the present disclosure. The example shown includes user interface 1500, output image 1505, synthetic object 1510, text prompt 1515, opacity parameter 1520, background layer 1525, and image cloning layer 1530. User interface 1500 is an example of, or includes aspects of, the corresponding element described with reference to FIGS. 3-6, 8, 13, 14, 21, and 22.

As an example shown in FIG. 15, image generation model 840 (described with reference to FIG. 8) generates output image 1505, which includes synthetic object 1510. The synthetic object 1510 is a synthetic variant of source object 1310 (refer to FIG. 13). Synthetic object 1510 is located in target region 1410 (refer to FIG. 14).

Output image 1505 is an example of, or includes aspects of, the corresponding element described with reference to FIG. 22. Text prompt 1515 is an example of, or includes aspects of, the corresponding element described with reference to FIGS. 3-6. Opacity parameter 1520 is an example of, or includes aspects of, the corresponding element described with reference to FIGS. 13 and 22. Background layer 1525 is an example of, or includes aspects of, the corresponding element described with reference to FIGS. 14, 21, and 22. In some examples, background layer 1525 corresponds to the input image 1405 (refer to FIG. 14). Image cloning layer 1530 is an example of, or includes aspects of, the corresponding element described with reference to FIG. 21.

FIG. 16 shows an example of a source region 1605 and a target region 1615 according to aspects of the present disclosure. The example shown includes input image 1600, source region 1605, source object 1610, and target region 1615. As an example shown in FIG. 16, source region 1605 is selected by user 100 and is marked with overlay. Target region 1615 is selected by user 100 and is marked with overlay.

Input image 1600 is an example of, or includes aspects of, the corresponding element described with reference to FIGS. 3-6, 13, 14, and 21. Source region 1605 is an example of, or includes aspects of, the corresponding element described with reference to FIGS. 3 and 17. Source object 1610 is an example of, or includes aspects of, the corresponding element described with reference to FIGS. 3, 13, 17, 21, and 22. Target region 1615 is an example of, or includes aspects of, the corresponding element described with reference to FIGS. 4-6, 14, and 18.

FIG. 17 shows an example of for generating a mask 1710 based on a source object 1705 according to aspects of the present disclosure. The example shown includes source region 1700, source object 1705, mask 1710, and bounding box 1715. As an example shown in FIG. 17, source region 1700 includes source object 1705. Mask 1710 is extracted based on source object 1705. Mask 1710 is in the shape of source object 1705. White area of mask 1710 corresponds to the shape of source object 1705, while black area of mask 1710 corresponds to background in source region 1700. The bounding box 1715 corresponds to source object 1705.

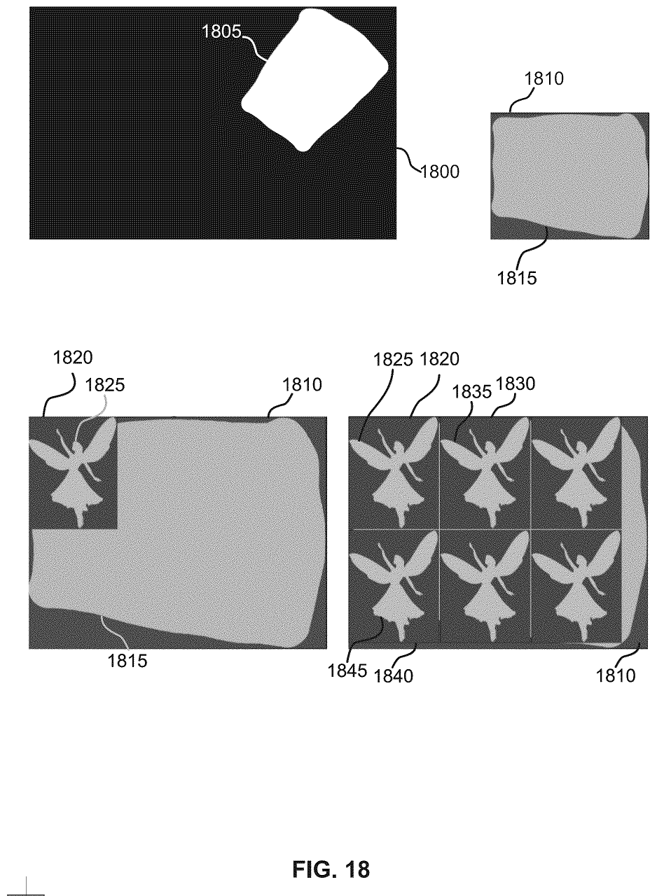

Source region 1700 is an example of, or includes aspects of, the corresponding element described with reference to FIGS. 3 and 16. Source object 1705 is an example of, or includes aspects of, the corresponding element described with reference to FIGS. 3, 13, 16, 21, and 22. Mask 1710 is an example of, or includes aspects of, the corresponding element described with reference to FIG. 18. Bounding box 1715 is an example of, or includes aspects of, the corresponding element described with reference to FIG. 18.

FIG. 18 shows an example of for generating a set of cloning regions according to aspects of the present disclosure. The example shown includes mask 1800, target region 1805, bounding box 1810, rotated target region 1815, first cloning region 1820, first object 1825, second cloning region 1830, second object 1835, third cloning region 1840, and third object 1845.

In an embodiment, mask 1800 corresponds to an input image. White area of mask 1800 corresponds to target region 1805 while black area of mask 1800 corresponds to background of the input image. Bounding box 1810 includes rotated target region 1815. In some examples, for single object placement, bounding box 1810 is used as it is (i.e., bounding box 1810 corresponds to a synthetic variant of a source object). In some cases, bounding box 1810 may be referred to as a destination bounding box.

In some examples, for “sparse” and “tight” spacing placement, the image generation model 840 (described with reference to FIG. 8) divides target region 1805 (also known as destination region) into a set of rectangles. Image generation model 840 rotates the bounding boxes of target region 1805 and the source object to align with the X-Y axis and translate them to the origin. Image generation model 840 calculates the transformation matrix to rotate and translate the rectangular back to target region 1805. Image generation model 840 calculates the rectangles for clones by placing the source rectangle in the destination rectangle in a grid-wise manner. For “sparse” placement option, image generation model 840 removes alternate rectangles such that no two rectangles can share an edge. Image generation model 840 applies the transformation matrix calculated in the above step to each rectangle and aligns them in the target region 1805.

In this example, bounding box 1810 is divided into six rectangles, which overlay rotated target region 1815. The first cloning region 1820 includes a first object 1825. The second cloning region 1830 includes a second object 1835. The third cloning region 1840 includes a third object 1845. The first object 1825 and the second object 1835 are arranged next to each other on the first row of the six rectangles. The third object 1845 is arranged on the second row of the six rectangles.

In an embodiment, machine learning model 825 (described with reference to FIG. 8) performs conversion of destination masks with auto-computed opacity. Machine learning model 825 performs image cloning generation based on masks and parameters. Once the proper masks along with their transformation matrix and corresponding prompts are created, image generation model 840 takes the mask, the transformation matrix, and corresponding prompt as inputs and generates an output image.

In some cases, the step about conversion of destination masks with auto-computed opacity and the step about cloning destination region generation based on masks and parameters are repeated based on the spacing parameter. If there is more than one mask computed in the previous step, machine learning model 825 performs the image generation step for each mask using the transformation matrix and prompts as described above.

Mask 1800 is an example of, or includes aspects of, the corresponding element described with reference to FIG. 17. Target region 1805 is an example of, or includes aspects of, the corresponding element described with reference to FIGS. 4-6, 14, and 16. Bounding box 1810 is an example of, or includes aspects of, the corresponding element described with reference to FIG. 17.

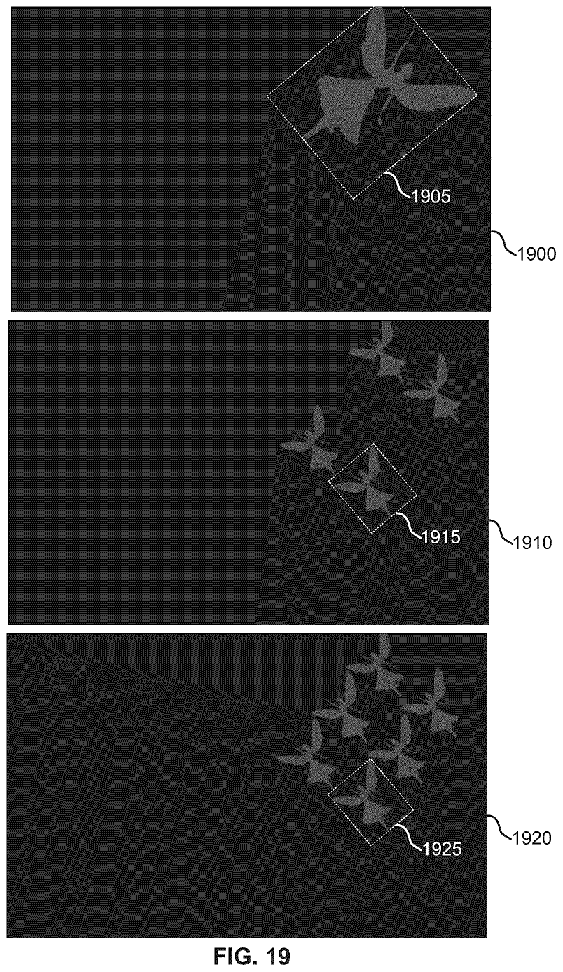

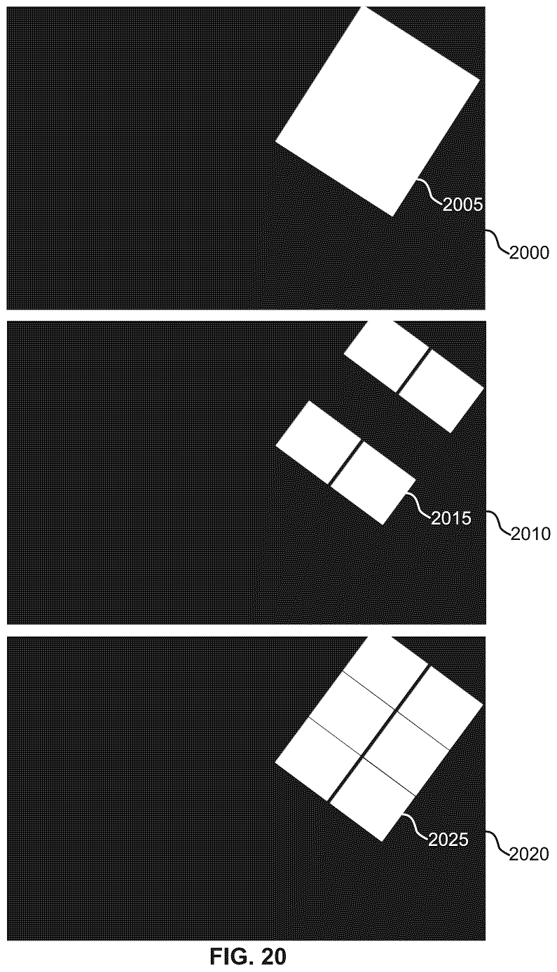

First cloning region 1820 is an example of, or includes aspects of, the corresponding element described with reference to FIGS. 19 and 20. Second cloning region 1830 is an example of, or includes aspects of, the corresponding element described with reference to FIGS. 19 and 20. Third cloning region 1840 is an example of, or includes aspects of, the corresponding element described with reference to FIGS. 19 and 20.

FIG. 19 shows an example of a transformation process based on a spacing parameter according to aspects of the present disclosure. The example shown includes first mask 1900, second mask 1910, and third mask 1920.

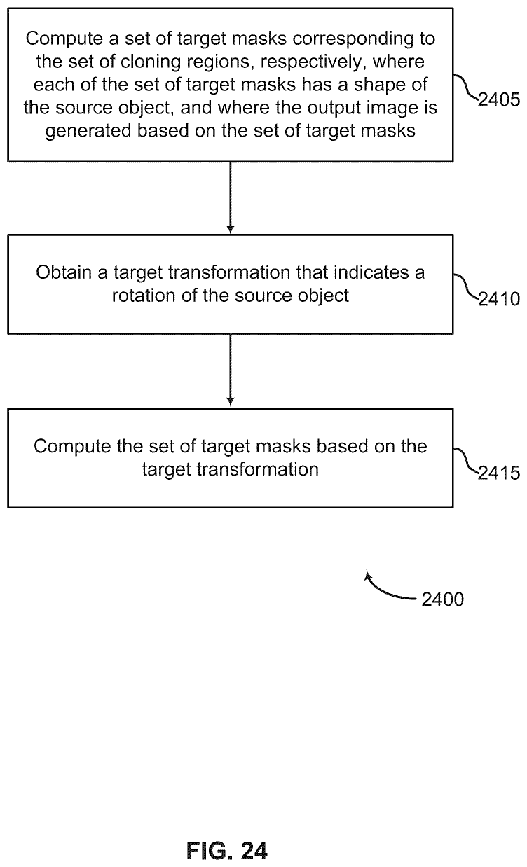

In some embodiments, image generation model 840 (described with reference to FIG. 8) generates a vector of rectangles where cloning needs to be done. In the case of single object option, the vector contains a single rectangle. Image generation model 840 calculates the masks for generative fill. For “low” creativity and “high” creativity, image generation model 840 directly converts these rectangles into masks. For “no” creativity (“none” is selected), image generation model 840 is configured to clone the original source object without any modifications. Image generation model 840 calculates the transformation matrices from the original source rectangle to the transformed destination rectangles. Image generation model 840 transforms the source object mask using these transformation matrices. In some cases, image generation model 840 applies a level of opacity to the transformed masks. First mask 1900, second mask 1910, and third mask 1920 may be computed by performing operation 2415 as described with reference to FIG. 24.

In an example at the top of FIG. 19, the first mask 1900 includes first cloning region 1905. In some cases, first mask 1900 is also referred to as a transformed clone mask. The first mask 1900 includes one cloning region (i.e., corresponding to single object). Spacing parameter is set to “single object”. Creativity parameter is set to “None”. First mask 1900 is an example of, or includes aspects of, the corresponding element described with reference to FIG. 20. First cloning region 1905 is an example of, or includes aspects of, the corresponding element described with reference to FIGS. 18 and 20.

In an example in the middle of FIG. 19, second mask 1910 includes second cloning region 1915. The second mask 1910 includes four cloning regions. Spacing parameter is set to “Sparse”. Creativity parameter is set to “None”. Second mask 1910 is an example of, or includes aspects of, the corresponding element described with reference to FIG. 20. Second cloning region 1915 is an example of, or includes aspects of, the corresponding element described with reference to FIGS. 18 and 20.

In an example at the bottom of FIG. 19, third mask 1920 includes third cloning region 1925. The third mask 1920 includes six cloning regions. Spacing parameter is set to “Tight”. Creativity parameter is set to “None”. Third mask 1920 is an example of, or includes aspects of, the corresponding element described with reference to FIG. 20. Third cloning region 1925 is an example of, or includes aspects of, the corresponding element described with reference to FIGS. 18 and 20.

FIG. 20 shows an example of a set of cloning regions based on a spacing parameter according to aspects of the present disclosure. The example shown includes first mask 2000, second mask 2010, and third mask 2020.

In some embodiments, image generation model 840 (described with reference to FIG. 8) generates a vector of rectangles where cloning needs to be done. In the case of single object option, the vector contains a single rectangle. Image generation model 840 calculates the masks for generative fill. For “low” creativity and “high” creativity, image generation model 840 directly converts these rectangles into masks.

In an example at the top of FIG. 20, the first mask 2000 includes first cloning region 2005. In some cases, the first mask 2000 is also referred to as a transformed clone mask. The first mask 1900 includes one cloning region (i.e., corresponding to single object). Spacing parameter is set to “single object”. Creativity parameter is set to “Low” creativity or “High” creativity. First mask 2000 is an example of, or includes aspects of, the corresponding element described with reference to FIG. 19. First cloning region 2005 is an example of, or includes aspects of, the corresponding element described with reference to FIGS. 18 and 19.

In an example in the middle of FIG. 20, second mask 2010 includes second cloning region 2015. The second mask 2010 includes four cloning regions. Spacing parameter is set to “Sparse”. Creativity parameter is set to “Low” creativity or “High” creativity. Second mask 2010 is an example of, or includes aspects of, the corresponding element described with reference to FIG. 19. Second cloning region 2015 is an example of, or includes aspects of, the corresponding element described with reference to FIGS. 18 and 19.

In an example at the bottom of FIG. 20, third mask 2020 includes third cloning region 2025. The third mask 2020 includes six cloning regions. Spacing parameter is set to “Tight”. Creativity parameter is set to “Low” creativity or “High” creativity. Third mask 2020 is an example of, or includes aspects of, the corresponding element described with reference to FIG. 19. Third cloning region 2025 is an example of, or includes aspects of, the corresponding element described with reference to FIGS. 18 and 19.

FIG. 21 shows an example of a user interface 2100 displaying a set of target regions according to aspects of the present disclosure. The example shown includes user interface 2100, input image 2105, source object 2110, first target region 2115, second target region 2120, third target region 2125, fourth target region 2130, creativity parameter 2135, spacing parameter 2140, transformation panel 2145, image cloning layer 2150, and background layer 2155. User interface 2100 is an example of, or includes aspects of, the corresponding element described with reference to FIGS. 3-6, 8, 13-15, and 22.

In some examples, first target region 2115, second target region 2120, third target region 2125 and fourth target region 2130 are selected by user 100, e.g., using a brush tool. Creativity parameter 2135 is set to “High”. Spacing parameter 2140 is set to “Sparse”. Transformation panel 2145 is located on the right-hand side of user interface 2100. Image cloning layer 2150 corresponds to a cloning mask. Background layer 2155 corresponds to the input image 2105. In some cases, a media output file includes image cloning layer 2150 and background layer 2155.

Input image 2105 is an example of, or includes aspects of, the corresponding element described with reference to FIGS. 3-6, 13, 14, and 16. Source object 2110 is an example of, or includes aspects of, the corresponding element described with reference to FIGS. 3, 13, 16, 17, and 22. Creativity parameter 2135 is an example of, or includes aspects of, the corresponding element described with reference to FIGS. 3-6, and 22. Spacing parameter 2140 is an example of, or includes aspects of, the corresponding element described with reference to FIGS. 3-6, and 22. Transformation panel 2145 is an example of, or includes aspects of, the corresponding element described with reference to FIG. 14.

Image cloning layer 2150 is an example of, or includes aspects of, the corresponding element described with reference to FIG. 15. Background layer 2155 is an example of, or includes aspects of, the corresponding element described with reference to FIGS. 14, 15, and 22.

FIG. 22 shows an example of a user interface 2200 displaying an output image 2205 according to aspects of the present disclosure. The example shown includes user interface 2200, output image 2205, source object 2210, first synthetic object 2215, second synthetic object 2220, third synthetic object 2225, fourth synthetic object 2230, creativity parameter 2235, spacing parameter 2240, opacity parameter 2245, a set of image cloning layers 2250, and background layer 2255. User interface 2200 is an example of, or includes aspects of, the corresponding element described with reference to FIGS. 3-6, 8, 13-15, and 21.

In some examples, image generation model 840 (described with reference to FIG. 8) generates output image 2205 based on input image 2105 and a set of image cloning parameters (e.g., creativity parameter 2235, spacing parameter 2240, opacity parameter 2245, style parameter). Output image 2205 includes a set of synthetic variants of the source object 2110, which comprises first synthetic object 2215, second synthetic object 2220, third synthetic object 2225, and fourth synthetic object 2230. First synthetic object 2215, second synthetic object 2220, third synthetic object 2225, and fourth synthetic object 2230 are located in first target region 2115, second target region 2120, third target region 2125, and fourth target region 2130, respectively.

In some examples, a set of image cloning layers 2250 includes a first image cloning layer, a second cloning layer, a third cloning layer, and a fourth cloning layer. The first image cloning layer includes a first cloning mask corresponding to first target region 2115. The second image cloning layer includes a second cloning mask corresponding to second target region 2120. The third image cloning layer includes a third cloning mask corresponding to third target region 2125. The fourth image cloning layer includes a fourth cloning mask corresponding to fourth target region 2130. Background layer 2255 corresponds to the input image 2105. Background layer 2255 is an example of, or includes aspects of, the corresponding element described with reference to FIGS. 14, 15, and 21. In some cases, a media output file includes the set of image cloning layers 2250 and background layer 2255.

Output image 2205 is an example of, or includes aspects of, the corresponding element described with reference to FIG. 15. Source object 2210 is an example of, or includes aspects of, the corresponding element described with reference to FIGS. 3, 13, 16, 17, and 21.

First synthetic object 2215 is an example of, or includes aspects of, the corresponding element described with reference to FIGS. 5 and 6. Second synthetic object 2220 is an example of, or includes aspects of, the corresponding element described with reference to FIGS. 5 and 6. Third synthetic object 2225 is an example of, or includes aspects of, the corresponding element described with reference to FIG. 5.

Creativity parameter 2235 is an example of, or includes aspects of, the corresponding element described with reference to FIGS. 3-6, and 21. Spacing parameter 2240 is an example of, or includes aspects of, the corresponding element described with reference to FIGS. 3-6, and 21. Opacity parameter 2245 is an example of, or includes aspects of, the corresponding element described with reference to FIGS. 13 and 15. For example, opacity parameter 2245 is set to “100%”.

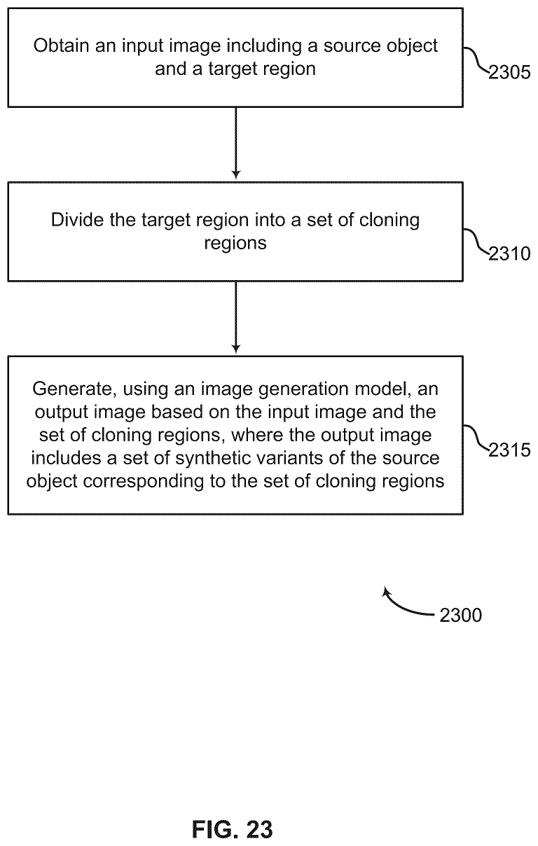

FIG. 23 shows an example of a method 2300 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2305, the system obtains an input image including a source object and a target region. In some cases, the operations of this step refer to, or may be performed by, a user interface as described with reference to FIGS. 3-6, 8, 13-15, 21, and 22.

At operation 2310, the system divides the target region into a set of cloning regions. In some cases, the operations of this step refer to, or may be performed by, a transformation component as described with reference to FIG. 8. In an embodiment, the transformation component divides the target region into multiple rectangles. The transformation component rotates bounding boxes of the target region and source object to align with the X-Y axis and translates them to the origin. The transformation component calculates a transformation matrix to rotate and translate the multiple rectangles back to the target region. The transformation component calculates the rectangles for clones or synthetic variants by placing the source rectangle in the destination rectangle in a grid-wise manner. For the sparse placement option indicated by a “sparse” spacing parameter, the transformation component removes alternate rectangles such that no two rectangles can share an edge. The transformation component applies the transformation matrix calculated in the above step to each rectangle and aligns them in the target region. An example illustrating operation 2310 is described with reference to FIG. 18.

At operation 2315, the system generates, using an image generation model, an output image based on the input image and the set of cloning regions, where the output image includes a set of synthetic variants of the source object corresponding to the set of cloning regions. In some cases, the operations of this step refer to, or may be performed by, an image generation model as described with reference to FIG. 8. The set of synthetic variants may look different from one another. In some examples, the set of synthetic variants look similar or identical to one another.

FIG. 24 shows an example of a method 2400 for computing a set of target masks according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2405, the system computes a set of target masks corresponding to the set of cloning regions, respectively, where each of the set of target masks has a shape of the source object, and where the output image is generated based on the set of target masks. In some cases, the operations of this step refer to, or may be performed by, an image generation model as described with reference to FIG. 8.

At operation 2410, the system obtains a target transformation that indicates a rotation of the source object. In some cases, the operations of this step refer to, or may be performed by, an image generation model as described with reference to FIG. 8.

At operation 2415, the system computes the set of target masks based on the target transformation. The set of target masks are used in subsequent operations by the system. In some cases, the operations of this step refer to, or may be performed by, an image generation model as described with reference to FIG. 8. In an embodiment, if a creativity parameter is set to “none”, the image generation model calculates transformation matrices from a source rectangle to transformed target rectangles, where the transformation matrices correspond to the target transformation, and transforms a source object mask using the transformation matrices to obtain the set of target masks. In some examples, the image generation model applies an opacity parameter to the set of target masks. In cases where a creativity parameter is set to “low” or “high”, the image processing apparatus directly converts these rectangles into masks. An example illustrating operation 2415 is described with reference to FIG. 19.

In FIGS. 13-24, a method, apparatus, non-transitory computer readable medium, and system for media processing are described. One or more aspects of the method, apparatus, non-transitory computer readable medium, and system include obtaining an input image including a source object and a target region; dividing the target region into a set of cloning regions; and generating, using an image generation model, an output image based on the input image and the set of cloning regions, where the output image includes a set of synthetic variants of the source object corresponding to the set of cloning regions.

Some examples of the method, apparatus, non-transitory computer readable medium, and system further include computing a set of target masks corresponding to the set of cloning regions, respectively, where each of the set of target masks has a shape of the source object, and where the output image is generated based on the set of target masks.

Some examples of the method, apparatus, non-transitory computer readable medium, and system further include obtaining a target transformation that indicates a rotation of the source object, where the set of target masks are computed based on the target transformation.

Some examples of the method, apparatus, non-transitory computer readable medium, and system further include obtaining a creativity parameter that indicates a degree of similarity between the source object and the set of synthetic variants, where the output image is generated based on the creativity parameter.

Some examples of the method, apparatus, non-transitory computer readable medium, and system further include obtaining a spacing parameter, where the target region is divided based on the spacing parameter.

Some examples of the method, apparatus, non-transitory computer readable medium, and system further include obtaining a text prompt that indicates an attribute of each of the set of synthetic variants, respectively, where the output image is generated based on the text prompt.

### Training

FIG. 25 shows an example of a method 2500 for training a diffusion model according to aspects of the present disclosure. In some embodiments, the method 2500 describes an operation of the training component 845 described for configuring the machine learning model 825 as described with reference to FIG. 8. The method 2500 represents an example for training a reverse diffusion process as described above with reference to FIGS. 9 and 11. In some examples, these operations are performed by a system including a processor executing a set of codes to control functional elements of an apparatus, such as the guided latent diffusion model described in FIG. 9.

Additionally or alternatively, certain processes of method 2500 may be performed using special-purpose hardware. Generally, these operations are performed according to the methods and processes described in accordance with aspects of the present disclosure. In some cases, the operations described herein are composed of various substeps or are performed in conjunction with other operations.

At operation 2505, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 2510, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 2515, starting with stage N, at each stage n, the system runs a reverse diffusion process to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 2520, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 2525, the system updates parameters of the model based on the comparison. For example, parameters of a U-Net (as described with reference to FIG. 10) may be updated using gradient descent. Time-dependent parameters of the Gaussian transitions can also be learned.

FIG. 26 shows an example of a step-by-step procedure for training a machine learning model according to aspects of the present disclosure. FIG. 26 shows a flow diagram depicting an algorithm as a step-by-step procedure 2600 in an example implementation of operations performable for training a machine-learning model. In some embodiments, the procedure 2600 describes an operation of the training component 845 described for configuring the machine learning model 825 as described with reference to FIG. 8. The procedure 2600 provides one or more examples of generating training data, use of the training data to train a machine learning model, and use of the trained machine learning model to perform a task.

To begin in this example, a machine-learning system collects training data (block 2602) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2604) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 2606). Initialization of the machine-learning model includes selecting a model architecture (block 2608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2610). The loss function is utilized to measure a difference between an output of the machine-learning model (i.e., predictions) and target values (e.g., as expressed by the training data) to be used to train the machine-learning model. Additionally, an optimization algorithm is selected (block 2612) to be used in conjunction with the loss function to optimize parameters of the machine-learning model during training, examples of which include gradient descent, stochastic gradient descent (SGD), and so forth.

Initialization of the machine-learning model further includes setting hyperparameters (block 2614) and setting initial values (block 2616) of the machine-learning model, examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2618) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a set of nodes that collectively form a set of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2620), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2620), the procedure 2600 continues training of the machine-learning model using the training data (block 2618) in this example.

If the stopping criterion is met (“yes” from decision block 2620), the trained machine-learning model is then utilized to generate an output based on subsequent data (block 2622). The trained machine-learning model, for instance, is trained to perform a task as described above and therefore, once trained is configured to perform that task based on subsequent data received as an input and processed by the machine-learning model.

FIG. 27 shows an example of a computing device 2700 for image processing according to aspects of the present disclosure. The computing device 2700 may be an example of the image processing apparatus 800 described with reference to FIG. 8. In one aspect, computing device 2700 includes one or more processors 2705, memory subsystem 2710, communication interface 2715, I/O interface 2720, user interface component(s) 2725, and channel 2730.

In some embodiments, computing device 2700 is an example of, or includes aspects of, the machine learning model of FIG. 8. In some embodiments, computing device 2700 includes one or more processors 2705 that can execute instructions stored in memory subsystem 2710 to perform media generation.

According to some aspects, computing device 2700 includes one or more processors 2705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2715 operates at a boundary between communicating entities (such as computing device 2700, one or more user devices, a cloud, and one or more databases) and channel 2730 and can record and process communications. In some cases, communication interface 2715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2720 is controlled by an I/O controller to manage input and output signals for computing device 2700. In some cases, I/O interface 2720 manages peripherals not integrated into computing device 2700. In some cases, I/O interface 2720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2720 or via hardware components controlled by the I/O controller.

According to some aspects, user interface component(s) 2725 enable a user to interact with computing device 2700. In some cases, user interface component(s) 2725 include an audio device, such as an external speaker system, an external display device such as a display screen, an input device (e.g., a remote-control device interfaced with a user interface directly or through the I/O controller), or a combination thereof. In some cases, user interface component(s) 2725 include a GUI.

Performance of apparatus, systems and methods of the present disclosure have been evaluated, and results indicate embodiments of the present disclosure have obtained increased performance over conventional technology. Example experiments demonstrate that the image processing apparatus and the machine learning model described in embodiments of the present disclosure outperforms conventional systems.

Embodiments of the present disclosure provide methods and apparatus to perform generative clone based on a creative level selected. The machine learning model performs auto-transformation of the source region on destination region based on the content around which it is cloned. The machine learning model divides the destination region based on the source region parameters and tool parameters.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image including a source object and a target region;
computing a target mask based on the source object and the target region, wherein the target mask has a shape of the source object and is located within the target region; and
generating, using an image generation model, an output image based on the input image and the target mask, wherein the output image includes a synthetic variant of the source object in the target region.

2. The method of claim 1, further comprising:
obtaining a creativity parameter that indicates a degree of similarity between the source object and the synthetic variant, wherein the output image is generated based on the creativity parameter.

3. The method of claim 1, wherein computing the target mask comprises:
extracting a source mask corresponding to the source object from the input image, wherein the target mask is based on the source mask.

4. The method of claim 1, wherein computing the target mask comprises:
dividing the target region into a plurality of cloning regions, wherein the target mask is located within one of the plurality of cloning regions, and wherein the output image includes a plurality of synthetic variants corresponding to the plurality of cloning regions.

5. The method of claim 4, further comprising:
obtaining a spacing parameter, wherein the target region is divided based on the spacing parameter.

6. The method of claim 1, wherein computing the target mask comprises:
obtaining a target transformation that indicates a rotation of the source object, wherein the target mask is computed based on the target transformation.

7. The method of claim 1, further comprising:
obtaining a text prompt that indicates an attribute of the synthetic variant, wherein the output image is generated based on the text prompt.

8. The method of claim 7, wherein:
the text prompt is generated based on the source object.

9. The method of claim 1, wherein computing the target mask comprises:
obtaining an opacity parameter indicating a level of opacity for the synthetic variant, wherein the target mask is generated based on the opacity parameter.

10. The method of claim 1, further comprising:
obtaining a style parameter indicating a style attribute for the synthetic variant, wherein the output image is generated based on the style parameter.

11. A non-transitory computer readable medium storing code for media processing, the code comprising instructions that, when executed by at least one processor, cause the at least one processor to perform operations comprising:
obtaining an input image including a source object and a target region;
dividing the target region into a plurality of cloning regions; and
generating, using an image generation model, an output image based on the input image and the plurality of cloning regions, wherein the output image includes a plurality of synthetic variants of the source object corresponding to the plurality of cloning regions.

12. The non-transitory computer readable medium of claim 11, the code further comprising instructions executable by the at least one processor to perform operations comprising:
computing a plurality of target masks corresponding to the plurality of cloning regions, respectively, wherein each of the plurality of target masks has a shape of the source object, and wherein the output image is generated based on the plurality of target masks.

13. The non-transitory computer readable medium of claim 12, the code further comprising instructions executable by the at least one processor to perform operations comprising:
obtaining a target transformation that indicates a rotation of the source object, wherein the plurality of target masks are computed based on the target transformation.

14. The non-transitory computer readable medium of claim 11, the code further comprising instructions executable by the at least one processor to perform operations comprising:
obtaining a creativity parameter that indicates a degree of similarity between the source object and the plurality of synthetic variants, wherein the output image is generated based on the creativity parameter.

15. The non-transitory computer readable medium of claim 11, the code further comprising instructions executable by the at least one processor to perform operations comprising:
obtaining a spacing parameter, wherein the target region is divided based on the spacing parameter.

16. The non-transitory computer readable medium of claim 11, the code further comprising instructions executable by the at least one processor to perform operations comprising:
obtaining a text prompt that indicates an attribute of each of the plurality of synthetic variants, respectively, wherein the output image is generated based on the text prompt.

17. A system comprising:
a memory component; and
a processing device coupled to the memory component, the processing device configured to perform operations comprising:
obtaining an input image including a source object and a target region;
computing a target mask based on the source object and the target region, wherein the target mask has a shape of the source object and is located within the target region; and
generating, using an image generation model, an output image based on the input image and the target mask, wherein the output image includes a synthetic variant of the source object in the target region.

18. The system of claim 17, further comprising:
a language generation model configured to generate a text prompt indicating an attribute of the synthetic variant based on the source object.

19. The system of claim 17, further comprising:
a user interface configured to obtain a creativity parameter, a spacing parameter, a style parameter, an opacity parameter, or any combination thereof.

20. The system of claim 17, further comprising:
a transformation component configured to compute a target transformation that indicates a rotation of the source object, wherein the target mask is computed based on the target transformation.
